(19) United States
(12) Patent Application Publication
(10) Pub. No.: US 2008/0201284 A1
(43) Pub. Date: Aug. 21, 2008

(54) Computer-Implemented Model of the Central Nervous System

(76) Inventors: Steven G. Massaquoi, Belmont, MA (US); Zhi-Hong Mao, Pittsburgh, PA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/063,135

(22) PCT Filed: Aug. 15, 2006
(86) PCT No.: PCT/US2006/031876

§ 371 Date: Feb. 7, 2008

Related U.S. Application Data
(60) Provisional application No. 60/708,632, filed on Aug. 15, 2005.
(60) Provisional application No. 60/735,599, filed on Nov. 12, 2005.

(51) Int. Cl. G06N 3/04; G06F 15/18

(52) U.S. Cl. 706/30; 706/27

(57) ABSTRACT

A computer-implemented model of the central nervous system includes at least one of a basal ganglia portion, a cerebral cortex portion coupled to the basal ganglia portion, or a cerebellum portion coupled to the cerebral cortex. Each one of the basal ganglia portion, the cerebral cortex portion, and the cerebellum portion is comprised of respective elements representative of real neuroanatomical structures of a central nervous system and the respective elements are adapted to perform functions representative of real neuroanatomical functions of the central nervous system. At least one of the basal ganglia portion, the cerebral cortex portion, or the cerebellum portion is adapted to control a plant.

### FIELD OF THE INVENTION

This invention relates generally to a model of a central nervous system (CNS) implemented in a computer and, more particularly, to a model of a mammalian CNS having model portions comprised of respective model elements representative of real neuroanatomical structures adapted to perform functions representative of real neuroanatomical functions, which is adapted to control a plant.

### BACKGROUND OF THE INVENTION

A variety of computer models of CNS functions have been developed. Some high-level models of CNS function employ substantially behavioral models, which attempt to emulate CNS functions without regard to the underlying structure of the CNS. For example, some artificial intelligence programs attempt to merely emulate verbal responses of a person in response to questions. The high-level models of CNS function merely attempt to represent an output response of a CNS in response to an input, without regard to internal structure of the CNS. Therefore, the high-level models of the CNS tend to provide only a limited representation of actual overall CNS functions.

In contrast, some low-level models of the CNS attempt to model behaviors and interconnections of individual neurons within the CNS. In order to fairly represent a CNS, a great number of neurons must be interconnected in a low-level computer model. Due to the high number of interconnected neurons and interconnected models thereof, the low level models tend to suffer from expense in implementation and, using currently available technology, an inability to process information at a speed representative of functions of a CNS, since the number of neurons in the CNS and associated processing is quite large. Also, having the large number of interconnected neurons, the low-level models tend to be directed to models of relatively small parts of the CNS, rather than to the overall CNS.

When applied to real world systems, for example, robots, both the high-level models and the low-level models of the CNS tend to generate behaviors that are only modestly animal-like or only modestly human-like.

It would, therefore, be beneficial to provide a computer-implemented model of the central nervous system having computer representations of real CNS structures at the level of functional groups of neurons, without the detailed level of individual neurons, in order to more accurately represent and/or generate real human behaviors, or alternatively, real animal behaviors. Such a computer-implemented model might also provide insight into CNS abnormalities or CNS damage.

### SUMMARY OF THE INVENTION

The present invention provides a computer-implemented model of the central nervous system (CNS) having computer representations of real CNS structures but without the detailed level of having only representations of individual neurons.

In accordance with one aspect of the present invention, a computer-implemented model of the central nervous system includes a basal ganglia portion, a cerebral cortex portion coupled to the basal ganglia portion, and a cerebellum portion coupled to the cerebral cortex portion. Each one of the basal ganglia portion, the cerebral cortex portion, and the cerebellum portion is comprised of respective elements representative of real neuroanatomical structures of a CNS and the respective elements are adapted to perform functions representative of real neuroanatomical functions of the CNS. At least one of the basal ganglia portion, the cerebral cortex portion, or the cerebellum portion is adapted to control a plant.

In accordance with another aspect of the present invention, a computer-implemented model of the central nervous system includes a basal ganglia portion, wherein the basal ganglia portion is comprised of basal ganglia elements representative of real neuroanatomical structures of a CNS and the basal ganglia elements are adapted to perform functions representative of real neuroanatomical functions of the CNS. The basal ganglia portion is adapted to control a plant.

In accordance with another aspect of the present invention, a computer-implemented model of a central nervous system includes a cerebellum portion, wherein the cerebellum portion is comprised of cerebellum elements representative of real neuroanatomical structures of a CNS and the cerebellum elements are adapted to perform functions representative of real neuroanatomical functions of the CNS. The cerebellum elements form a proportional-integral-derivative (PID) structure. The cerebellum portion is adapted to control a plant.

### BRIEF DESCRIPTION OF THE DRAWINGS

The foregoing features of the invention, as well as the invention itself may be more fully understood from the following detailed description of the drawings, in which:

FIG. 1 is a block diagram showing a computer model of a central nervous system having portions, namely, a cerebral cortex portion, a basal ganglia portion, a cerebellum portion, and a brainstem/spinal cord portion in communication with a plant;

FIG. 2 is a block diagram showing elements of the basal ganglia portion and the cerebral cortex portion of the computer model of FIG. 1, the basal ganglia portion including a striatum element and the cerebral cortex portion associated with a thalamus portion;

FIG. 3 is a block diagram showing further details of the striatum element of FIG. 2;

FIG. 3A is a lock diagram showing still further details of the striatum element of FIG. 2;

FIG. 4 is a block diagram of an exemplary gate structure used to represent some of the elements of the basal ganglia portion of FIG. 2;

FIG. 5 is a block diagram showing some of the elements of the basal ganglia portion of FIG. 2 as coupled via a thalamus unit to the cerebral cortex portion of FIG. 2;

FIG. 5A is a block diagram showing an arrangement of two sets of units spanning some of the elements of the basal ganglia portion of FIG. 2 as coupled via a thalamus unit to the cerebral cortex portion of FIG. 2;

FIGS. 6, 6A and 6C are a block diagrams showing a variety of representations of a thalamocortical module, which forms a part of the thalamus portion of FIG. 2, as coupled to the cerebral cortex portion of FIG. 2;

FIG. 6B is a graph showing a qualitative relationship between the input and output signals of the thalamocortical modules of FIGS. 6, 6A, and 6C;

FIG. 7 is a block diagram showing a plurality of thalamocortical modules, which form a part of the thalamus portion of FIG. 2, as coupled to the cerebral cortex portion of FIG. 2;

FIG. 8 is a block diagram showing some of the elements of the basal ganglia portion of FIG. 2 coupled to the cerebral cortex portion of FIG. 2 via a thalamocortical module;

FIG. 8A shows a set of vector notations associated with the basal ganglia portion of FIG. 8;

FIG. 8B is a graph showing waveforms associated with the thalamocortical module of FIG. 8;

FIG. 9 is a block diagram showing another arrangement of some of the elements of the basal ganglia portion of FIG. 2 coupled to the cerebral cortex portion of FIG. 2 via a plurality of thalamocortical modules;

FIG. 9A shows a set of vector notations associated with the basal ganglia portion of FIG. 9;

FIG. 10 is a graph showing waveforms associated with the arrangement of FIG. 9;

FIG. 10A is a graph showing further waveforms associated with the arrangement of FIG. 9;

FIG. 11 is a block diagram showing a plurality of thalamocortical modules as participating in the cerebral cortex portion of FIG. 1, providing a signal to a plant via an integrator representing a motor cortex portion;

FIG. 12 shows graphs indicative of movements and velocities of the plant of FIG. 11;

FIG. 13 is a block diagram showing a plurality of thalamocortical modules, which connect the cerebral cortex portion and the basal ganglia portion of FIG. 2, providing antagonist and/or an agonist signals to a plant via a plurality of integrators representing a motor cortex portion;

FIG. 14 is a block diagram showing real neuroanatomical structures and a primary signal pathway;

FIG. 14A is a block diagram showing computer-implemented elements that can be used to represent the real neuroanatomical structures and the primary signal pathway of FIG. 14;

FIG. 14B is a block diagram showing real neuroanatomical structures and a secondary signal pathway;

FIG. 14C is a block diagram showing computer-implemented elements that can be used to represent the real neuroanatomical structures and the secondary pathway of FIG. 14B;

FIG. 14D is a block diagram showing computer-implemented elements that can be used to represent real neuroanatomical structures and further pathways;

FIG. 14E is a block diagram showing computer-implemented elements that can be used to represent real neuroanatomical structures and still further pathways; and

FIG. 15 is a block diagram showing elements of the cerebral cortex portion and the cerebellum portion of FIG. 1, wherein the cerebellum portion includes proportional elements, differentiating elements, and integrating elements, forming a proportional-integrating-differentiating (PID) controller.

### DETAILED DESCRIPTION OF THE INVENTION

Before describing the present invention, some introductory concepts and terminology are explained. As used herein, the term “plant” is used to describe a system being controlled. For example, a plant can be a computer-simulated limb of an animal of person, and the control can be associated with bending of the simulated limb. A plant can also be two computer-simulated legs of the animal or person, and the control can be associated with simulated walking. The plant can also be an entire computer-simulated body of the animal or person, and the control can be associated with more complex simulated bodily motions. In other arrangements, the computer-simulated parts described above, can instead be real mechanical assemblies, which represent the parts of the animal or person, and the control can include control of motors and/or actuators.

While the plant is described herein to be representative of a body part of an animal or person, it should be understood that the plant can be any system that is controlled, which may or may not have similarity to a body or body part of an animal or person. The portion of the plant that receives input signals and exerts control is referred to herein as an “actuator” (e.g. muscle that exerts a force, a gland that secretes a hormone, or a motor that exerts a torque-). The system component upon which the actuator acts is referred to herein as a “load” (e.g. skeleton, or target organ that responds to a hormone, or a vehicle).

Various computer-implemented models of portions of a human or animal central nervous system (CNS) are described below. When applied to a computer-simulated plant, the computer-implemented models of the CNS can control the computer-simulated plant. With this arrangement, the computer-implemented models of the CNS can be used in a variety of ways. For example, for a computer-implemented model of the CNS coupled to a computer-simulated arm, various portions of the computer-implemented model of the CNS can be intentionally altered, degraded, or and/or activated inappropriately in order to assess, for example, tremor of the computer-simulated arm, which can appear in a real arm when a similar part of a real CNS is malfunctioning. In this way, real neuroanatomical alterations that yield neurophysiological malfunctions can be better understood.

When applied to real mechanical body parts, the computer-implemented models of the CNS can control the mechanical body parts. With this arrangement, a computer-implemented model of the CNS can control movement, for example, of a robot.

As used herein, when referring to the central nervous system or to a corresponding computer-implemented model of the CNS, the term “neuronal component” refers to a processing structure that accepts a defined set of potentially time-varying input signals and generates a single potentially time varying output signal according to a mathematical rule. The single output may be directed identically and simultaneously to multiple targets neuronal components or systems, or may be directed with different scalings (proportions, weightings) and/or with different delays.

The term “unit” is used herein to describe one or a group of associated neuronal components that is generally activated at the same time to perform a group function. The function of the different neuronal components may be identical, or may be a new function that is emergent from the cooperation of the neuronal components. The output of a unit may be a single signal, or a defined set of multiple outputs. For example, one unit can be comprised of one thousand neuronal components, each of which activates generally at the same time to move a muscle or a group of muscles. However, another unit can be comprised of more than one thousand neuronal component or fewer that one thousand neuronal components, for example, nine neuronal components, each of which activates generally at the same time to generate a set of one or more output signals that is unlike that which each might generate alone.

The term “neuroanatomical element” or simply “element” is used herein to describe one or more units that are grouped together by description and possibly also functionally coupled together, which generally have the same type of function and are localized in a neuroanatomical structure (e.g. nucleus, or subnucleus).

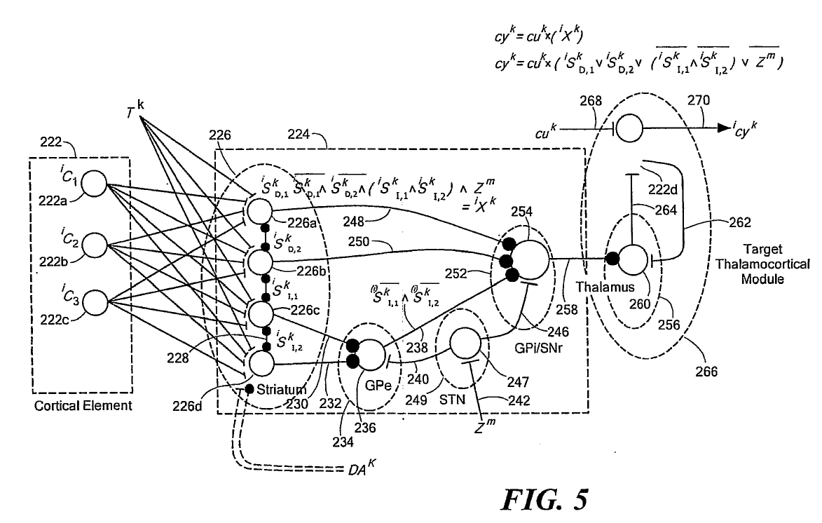

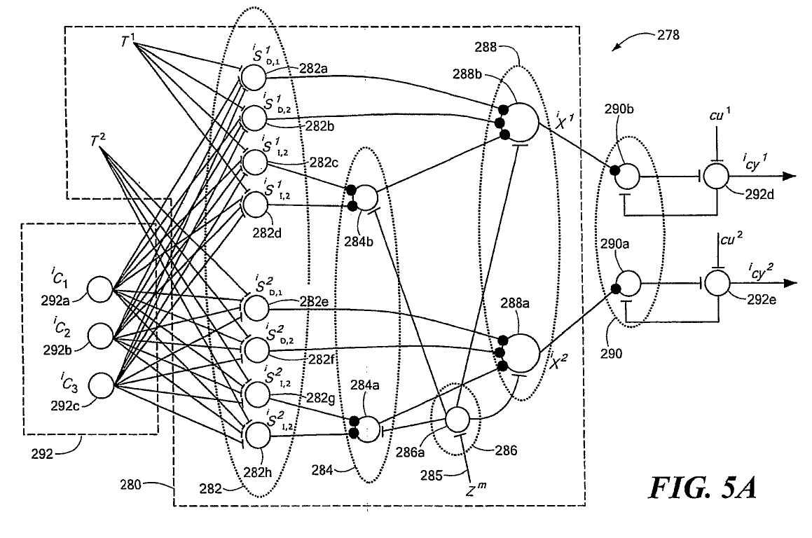

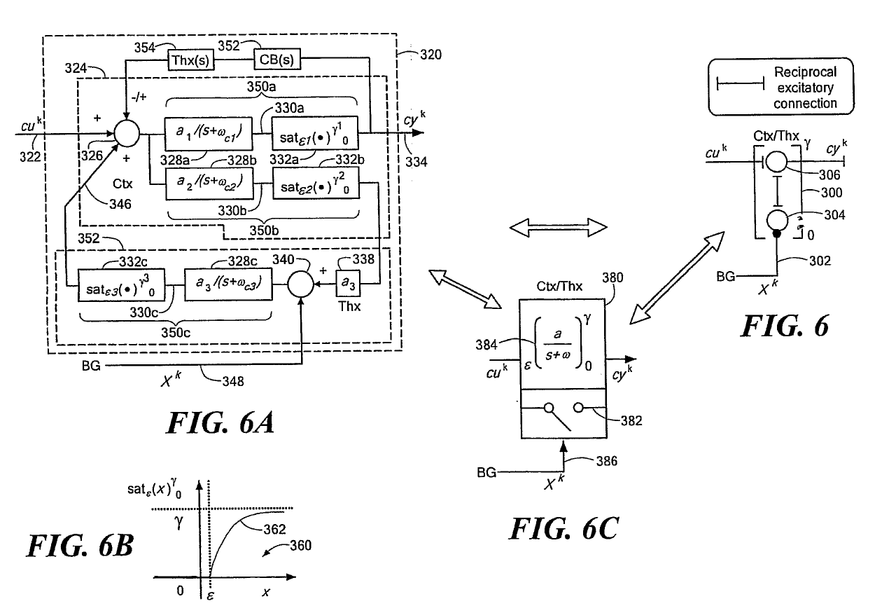

The term “module” as used herein is used to describe two or more units coupled together, each unit generally having a different function. For example, a module, comprised of basal ganglionic units can represent a basal ganglia function of the brain, each element representative of a sub-structure (e.g. a neuroanatomical nucleus) of the basal ganglia. As another example, an element of a thalamus can be coupled to a unit of a cerebral cortex to form a thalamocortical module described more fully below in conjunction with FIG. 6. The module is thus a functional structure that typically spans multiple neuroantomical locations and includes units from multiple elements, and can be used as a building block as more fully described below in conjunction with FIGS. 5 and 5A.

The term “portion” as used herein is used to described one or more modules grouped by description and possibly also coupled together to represent replications of a module (e.g., as a building block) generally representing a substantial portion of the central nervous system. For example, a basal ganglia portion can be comprised of one or more replications of a basal ganglia module.

As used herein, the term “link” is used to refer to a coupling between two units, elements, modules, or portions, which is understood to possibly include a large number of signal channels that each conveys a signal or signals from individual or subsets of neuronal components within one unit (element, module, or portion) to and/or from individual or subsets of neuronal components within another unit (element, module, or portion). Owing to the possible multiplicity of parallel signal channels within a link, links are can be represented as signal vectors. When activated, one particular unit can generate one or more so-called “excitatory signals” on an “excitatory link” in order to promote an activity, for example, a muscle movement. However, when activated, another particular unit (element, module, or portion) can generate one or more so-called “inhibitory signals” on an “inhibitory link” in order to inhibit an activity. Links that potentially convey a mixture of excitatory and inhibitory signals are designated with arrows at one or both ends. Links that convey exclusively excitatory signals are designated with an orthogonal terminal bar at one or both ends, or an arrow with a “+” sign at one or both ends. Links that convey exclusively inhibitory signals are designated with a dark ball at one or both ends, or an arrow with a “−” sign at one or both ends The activation signal and the inhibition signal are referred to herein as “unit signals” or merely “signals.”

The above-described signal associated with a unit (element, module, or portion) can be a generally digital signal having two states. However, in other arrangements described more fully below, the signal associated with a unit (element, module, or portion) can have a more analog characteristic, for example, a ramping characteristic, or for another example, a multi-level characteristic, or in general any waveform that may take on values continuously or intermittently in time. The latter are referred to as “point processes”. Signals may also be ‘stochastic’ or probabilistic in that they may inherently consist of waveforms that are specified only in terms of a probabilistic distribution rather than a specific deterministic formula.

While some signals below are represented in analog form, it will be understood that in a computer-implemented model, the signals can be digitally represented as digitally encoded time samples of the analog signals. Similarly, while some mathematical functions are described below to be continuous analog functions, in a computer-implemented model, the same functions can be performed upon digital time samples.

As used herein, the term “gate structure” is used to refer to an electronic or software logical structure that can receive input signals and that can provide an output signal according to a logical combination of the input signals. For example, a gate structure can receive digital two-state one-bit input signals and can provide a two-state one-bit output signal having a state according to a predetermined logical combination of states of the input signals. For another example, a gate structure can receive digital multi-bit (e.g., digital byte or word) input signals and can provide a digital multi-bit output signal having a value according to a combination of the input signals. In some arrangements, the gate structure is thresholded so that an input signal below a threshold value has no affect upon the output signal.

As will be understood from discussion below, a unit or an element can, in some instances, be represented by a gate structure. That is, a gate structure is a functional abstraction of a unit or element that emphasizes its effectively binary and logical operation.

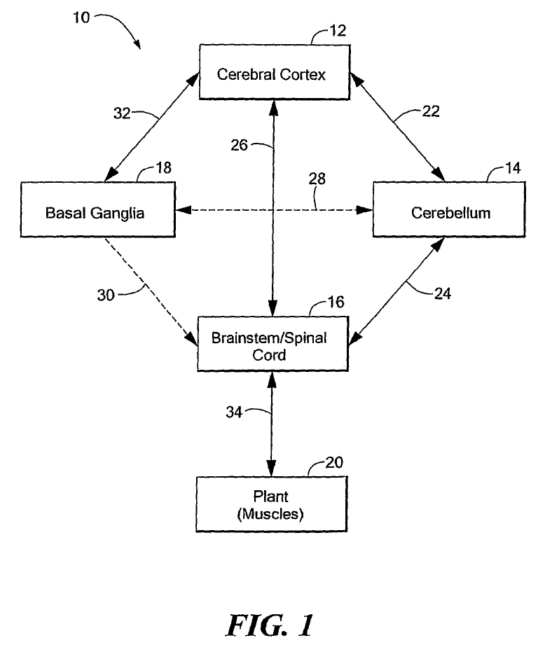

Referring to FIG. 1, a computer-implemented model 10 of the central nervous system (CNS) includes a cerebral cortex portion 12 coupled with a bidirectional link 22 to a cerebellum portion 14. The cerebellum portion 14 is coupled with a bidirectional link 24 to a plant 16. The spinal cord portion 16 is coupled with a bidirectional link 34 to a plant. The cerebral cortex portion 12 is also coupled with a bidirectional link 32 to a basal ganglia portion 18.

A bidirectional link 28 between the basal ganglia portion 18 and the cerebellum portion 14 and a link 30 between the basal ganglia portion 18 and the brainstem/spinal cord portion 16 are shown as optional by way of dashed lines.

The model portions 12, 14, and 18 are representative of real neuroanatomical portions of an animal or human CNS, which portions provide functions representative of real functions of those portions of a CNS.

As described more fully below, the basal ganglia portion 18, the cerebellum portion 14, the spinal cord portion 16, and the cerebral cortex portion 12 are each comprised of model “elements,” wherein, like the portions 12, 14, and elements of each one of the portions 12, 14, and 18 of the model 10 are representative of a real neuroanatomical structure of a CNS adapted to perform functions representative of a real CNS. The brainstem/spinal cord portion 16 is similarly comprised of respective elements.

As also described more fully below, the cerebral cortex portion 12 in combination with the cerebellum portion 14 and the brainstem/spinal cord portion 16 can generate actions of the plant 20. In a real CNS, the cerebral cortex portion 12 is associated with higher conscious functions, and therefore, the actions of the plant 20 can be consciously driven. The basal ganglia portion 18 is described below to provide some types of processing that is supportive of the processing provided by the cerebral cortex portion 12. The support provided by the basal ganglia portion 18 enables the cerebral cortex portion 12 to direct more of its attention elsewhere. Therefore, actions of the plant 20 can be controlled in part also by the cerebral cortex portion 12 together with the basal ganglia portion 18, in a less conscious fashion.

The links 22-34 can each include any number of excitatory links and/or inhibitory links.

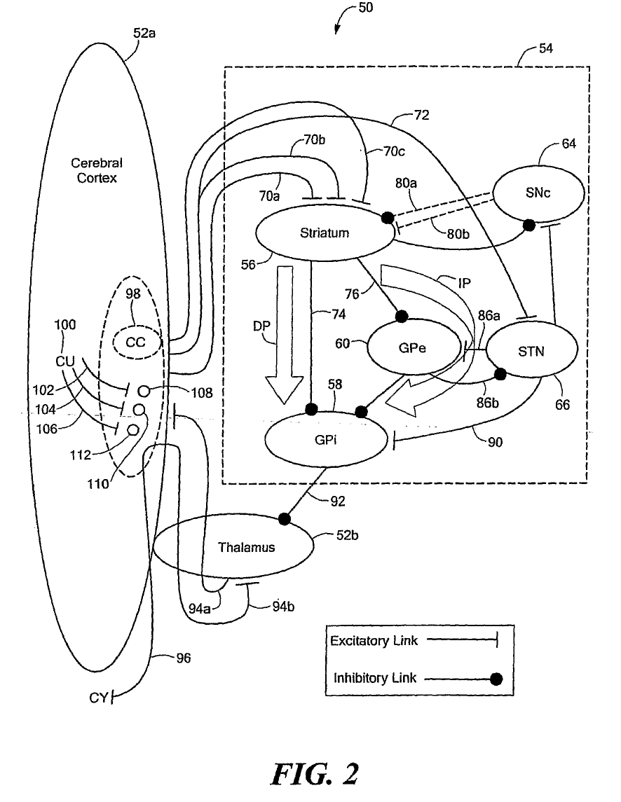

Referring now to FIG. 2, another computer-implemented model 50 of the central nervous system includes a main cerebral cortex portion 52a, coupled to a thalamus portion 52b, which is coupled to a basal ganglia portion 54. It will be appreciated that the thalamus portion 52b, which is a part of a thalamus, is closely associated with the cerebral cortex portion 52a. The thalamus portion 52b acts as a signal passageway from the basal ganglia portion 54 to the cerebral cortex portion 52a. It will also become apparent from discussion below, that the thalamus portion 52b can be comprised of one or more thalamus elements or units (not shown). The cerebral cortex portion 52a and thalamus portion 52b can together be the same as or similar to the cerebral cortex portion 12 of FIG. 1, and the basal ganglia portion 54 can be the same as or similar to the basal ganglia portion 18 of FIG. 1.

It should be understood that the computer-implemented model 50 can form a part of the computer-implemented model 10 of FIG. 1. However, as will be better understood from discussion below, the computer-implemented model 50 can be a stand alone computer-implemented model, capable of controlling the plant 30, for example, via the links 30, 26 and 34 of FIG. 1.

The basal ganglia portion 54 includes a striatum element 56. The striatum element 56 is coupled to the cerebral cortex portion 52a with a plurality of excitatory links, here three excitatory links 70a, 70b, 70c are shown. Excitatory links are represented by lines with terminating orthogonal line segments and inhibitory links are represented by lines with terminating dots. Signal direction is toward the terminating feature.

Each one of the excitatory links 70a-70c is coupled to a respective unit within the cerebral cortex portion 52a. The units from which the links 70a-70c emanate are represented by a CC designation, which designates a so-called “cerebral context” or “cerebral context vector.” The CC will be understood to be associated with a conscious or an unconscious “state” within the cerebral cortex portion 52a, which, in turn is represented by an activation of a set of units in the cerebral cortex portion 52a. The activation can be generated by a conscious thought, for example, a conscious thought associated with a foot movement to step on an automobile brake, or an unconscious thought, for example, an unconscious, more reflexive, thought associated with a foot movement to step on an automobile brake, or example, in response to a visual cue.

The basal ganglia portion 54 can also include an internal globus pallidus/substantia nigra pars reticulata (GPi/SNr) element 58 coupled to the striatum element 56 with an inhibitory link 74 and an external globus pallidus (GPe) element 60 coupled to the striatum element 56 with an inhibitory link 76. The GPe element 60 is coupled to the GPi/SNr element 58 with an inhibitory link 78. The inhibitory link 74 forms a so-called “direct pathway” (DP) which, as will be better understood from discussion below, can promote an activity, for example, a muscle movement. The inhibitory links 76, 78 and the GPe element 60 form a so-called “indirect pathway” (IP), which, as will be better understood from discussion below, can inhibit an activity.

The GPi/SNr element 58 is coupled to the thalamus portion 52b with an inhibitory link 92. The thalamus portion 52b is the input portion of the cerebral cortex portion 52a that receives input from the basal ganglia. The thalamus portion 52b is coupled back to the main cerebral cortex portion 52a with an excitatory link 94a, which can carry an excitatory signal to the cerebral cortex portion 52a, and also with another excitatory link 94b, which can carry an excitatory signal from the cerebral cortex portion 52a back to the thalamus portion 52b. The links 94a, 94b form a so-called “reverberatory loop” which is further described below.

The link 94a couples to one or more units, here three units 108-112, within the main cerebral cortex portion 52a. An excitatory signal carried on the excitatory link 94a results in a gating action, wherein one or more of the units 108-112 allows a signal, CU, which can be generated within the main cerebral cortex portion 52a, to pass through the units 108-112, resulting in an activation signal CY on an excitatory link 96. The excitatory link 96 can couple to any portion of the central nervous system (CNS). Referring again to FIG. 1, for example, the excitatory link 96 can couple via one or more of the links 28, 30, and 32. Therefore, the signal CY 96 can couple back to the cerebral cortex portion 12, to the cerebellum portion 14, to the brainstem/spinal cord portion 16, or to the basal ganglia portion 18 of FIG. 1. When coupled to the brainstem/spinal cord portion 16, the signal CY 96 can result, for example, in an action of the plant 20 of FIG. 1, which could be the activation of a muscle or mechanical actuator. When coupled to the cerebral cortex portion 12, the signal CY 96 can also result in action of the plant 20 of FIG. 1 as will become apparent from discussion below.

The basal ganglia portion 54 can also include a substantia nigra pars compacta (SNc) element 64 coupled to the striatum element 56 with an inhibitory link 80a and with an excitatory link 80b.

The basal ganglia portion 54 can also include a subthalamus nucleus (STN) element 66 coupled to the cerebral cortex portion 52 with a excitatory link 72, to the SNc element 64 with an excitatory link 84, to the GPi/SNr element 58 with an excitatory link 90, and to the GPe element 60 with an excitatory link 86a and with an inhibitory link 86b.

From discussion below, it will be understood that the basal ganglia portion 54 can provide an auxiliary processing function able to offload some of the processing from the main cerebral cortex portion 52a. It will be understood that the basal ganglia portion 54 can receive a cortical context (CC) from the main cerebral cortex portion 52a and can allow or fail to allow a signal CU to pass to an output signal CY in response thereto. The signal CY can be directed, for example, to the brainstem/spinal cord portion 16 (FIG. 1), back to the main cerebral cortex portion 52a, or to the cerebellum portion 14 of FIG. 1.

As will be further understood from discussion below, the output CY 96 can be held in abeyance under control of a signal carried on the link 72. Therefore, in effect, the cortical context CC 98 is representative of a particular cortical context that can act to channel the main cortical signal CU 100 to the main cortical output signal CY 96. The CC 98 achieves this affect by control of a signal in the direct path (DP) inhibitory link 74 that overrides the activation of GPi/SNr 58 from the excitatory links 72 to the STN and 90 to the GPi/SNr 58. Therefore, the striatum element 56 and the STN element 68, and the thalamus portion 52b can serve as a gating element that controls an output signal on link 96 from the main cerebral cortex portion 52a. In other words, in response to a cortical context CC 98, basal ganglionic thalamic neurons ordinarily act to enable or disable the cortical output neurons 108-112 that are being driven by other inputs CU 100, rather than to drive the cortical neurons 108-112 directly.

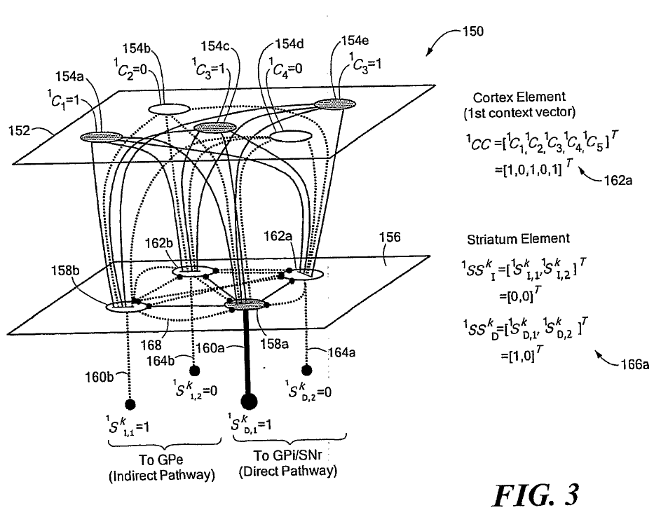

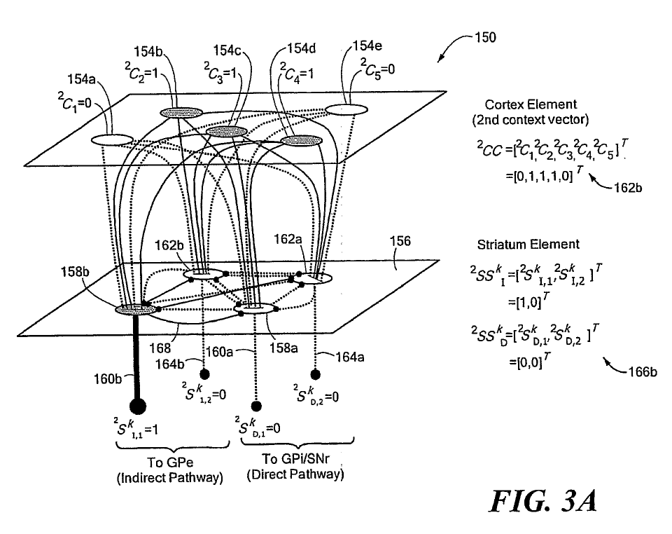

In operation, as further described below in conjunction with FIGS. 3 and 3A, the striatum element 56 can provide a so-called “winner(s)-take-all” function in which any particular pattern of CC states of input signals carried on the excitatory links 70a-70c from the main cerebral cortex portion 52a, typically results in one or more activated signals within either the link 74 or the link 76, i.e., within either the direct pathway DP inhibitory link 74 or the indirect pathway IP inhibitory link 76. Especially after learning, which is discussed further below, one pathway or the other transmits activity while the other does not. Therefore, any particular cerebral context CC 98 is ultimately associated either with an excitation or an inhibition of the signal CY.

As also further described below in conjunction with FIGS. 3 and 3A, the SNc element 64 can influence the striatum element 56, resulting in the striatum element 56 essentially learning mappings (associations) between cerebral contexts CCs 98 and output signals to send to the links 74, 76.

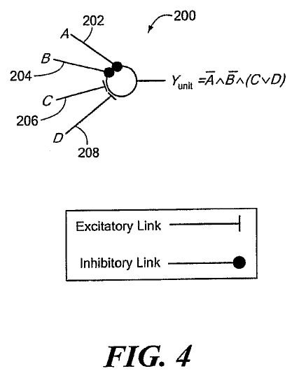

A gate structure representation of the various elements of FIG. 2 is described below in conjunction with FIG. 4. Let it suffice here to say that each one of the elements 56, 58, 60, 64, 66 can be represented by a respective gate structure.

While one of each of the elements 56, 58, 60, 64, 66 is shown, it should be appreciated that the elements 56, 58, 60, 64, 66 can be replicated any number of times. The basal ganglia portion 54 can include replications, each arranged as another basal ganglionic functional module, represented, for example, as a basal ganglia portion 224 (module) as shown in FIG. 5, which is replicated twice in the basal ganglia portion 280 of FIG. 5A.

Referring briefly ahead to FIG. 5, each basal ganglia portion 224 can be adapted to receive a respective (ith) input cerebral context ⁱCC, and each (kth) basal ganglia portion can be adapted to generate a respective output signal ⁱoverbar X^{k} transmitted by inhibitory link 258 under the control of a respective (mth) control link Z^{m} 242 comparable to the link 72. The number of cerebral contexts ⁱCC, basal ganglia portion net outputs [X^{k}] transmitted by inhibitory link 258, and modular control inputs Z^{m} 242, need not be equal. Various arrangements of replications of the model 50 are described more fully below in conjunction with FIGS. 5A and 7-9.

The basal ganglia portion 54 can include signal time delays (not shown) in any one or in all of the links, in order to represent real CNS function. However it may be desirable in some arrangements to provide no time delays, or minimal time delays, so that the basal ganglia portion 54 can provide a fastest response time to a cortical context CC.

Referring now to FIG. 3, a computer-implemented model 150 includes a particular cerebral cortex (¹CC) signal provided by a set of units 154a-154e within a cerebral cortex portion 152, which can be within the cerebral cortex portion 52 of FIG. 2 as represented by the CC 98. Designations ¹C₁-¹C₅ are representative of values of signals generated by respective ones of the units 154a-154e within the cerebral cortex portion 152, and a vector notation 162 is also representative of the ¹CC.

The model 150 also includes a striatum element 156, which can be representative of the striatum element 56 of FIG. 2. The striatum element 156 includes units 158a, 158b coupled to a direct pathway link 160a and an indirect pathway link 160b, respectively. The direct pathways link 160a can be the same as, a constituent of, or similar to the direct pathway link 74 of FIG. 2 and the indirect pathway slink 160b can be the same as, a constituent of, or similar to the indirect pathway link 76 of FIG. 2.

The striatum element 156 can also include units 162a, 162b coupled to a direct pathway link 164a and an indirect pathway link 164b, respectively. The direct pathways link 164a can be the same as or similar to the direct pathway link 74 of FIG. 2 and the indirect pathway slink 164b can be the same as or similar to the indirect pathway link 76 of FIG. 2. However, as described above, the elements within the basal ganglia portion 54 of FIG. 2 can be replicated any number of times, and therefore, the links 164a, 164b can be representative of links associated with replications of the basal ganglia portion 54 and of the striatum element 56 therein. Designations S_{I} and S_{D} are representative of values of signals generated by respective ones of the units 158a, 158b, 162a, 162b within the striatum portion 156, and vector notations 162a, 166a are also representative of signals.

The striatum element 156 shown includes four striatal units 158a, 158b, 162a, 162b. However, a striatum element can include arbitrary numbers of striatal units that will send links through either the direct pathway 74 or the indirect pathway 76. The striatum element 156 contains a plurality of lateral inhibitory links coupling the units 158a, 158b, 162a, 162b, of which the lateral inhibitory link 168 is but one example.

In operation, the cortical context ¹CC 162 results in a single active output 160a only within the direct pathway 74.

While only a single active output 160a is shown originating from the striatal unit 158a, more than one striatal unit may be active simultaneously. However, after learning, according to the winner(s)-take-all principle described above, typically all active striatal units will have links that travel within either the direct path (DP) 74 (FIG. 2) or indirect path (IP) 76 (FIG. 2), but not both. That is, unit 158a and possibly unit 162a can be active, or unit 158b and possibly unit 162b can be active. Replications of the striatum element 156 lie in different basal ganglionic modules as described, for example, in conjunction with FIG. 5A, where two modules are shown within a basal ganglia portion 280. Within one basal ganglionic module, the active striatal units within the striatal element 156 of that module may have links that travel within the direct path DP (e.g., 74 of FIG. 2) associated with that module. Within another basal ganglionic module, the active striatal units within the striatal element 156 of that module may have links that travel within the IP (e.g., 76 of FIG. 2) of that module. Over time, the striatal units within one striatal element may change from active to inactive, or from inactive to active, independently of striatal units in a different striatal element.

Referring now to FIG. 3A, in which like elements of FIG. 3 are shown having like reference designations, the computer-implemented model 150 is again shown, but for a different cortical context ²CC, represented by a different signals ²C₁-²C₅, and a different vector 162. The indicated signals ²C₁-²C₅ result in a single active output signal on the link 164b generated by the unit 162b.

While particular single active outputs are shown in FIGS. 3 and 3A in response to particular input signals ⁱC₁-ⁱC₅, in some arrangements, the mapping of the input signals ⁱC₁-ⁱC₅ to a certain active output signals can also be a learned characteristic. In other words, when first presented with the vector 162, a single active output signal on the link 164b need not result. Instead, there can be no active output signal, or a plurality of partially active output signals on a respective plurality of the output links 160a, 160b, 164a, 164b. Only after a number of receipts of signal from the cerebral cortex represented by a vector 166b does the single active output on the link 164b result.

The learned behavior is typically associated with positive or negative rewards presented by an SNc element of a real central nervous system (CNS), which is represented by the SNc element 64 of FIG. 2 along the inhibitory link 80a or the excitatory link 80b to the striatum element 52 (FIG. 2). In a real CNS, the positive and negative rewards can be associated with an amount of dopamine presented by the SNc element to the striatum element in response to a positive outcome. A conscious cortical context CC can be used to generate a conscious response by the cerebral cortex (initially bypassing the basal ganglia) resulting in satisfaction. For example, a conscious perception of a pedestrian stepping in front of one's automobile typically initiates stepping on the brake. If the pedestrian is not struck, a feeling of reward is associated with dopamine release in the striatum from the SNc. The dopamine facilitates the connections between the ⁱCC (98 FIG. 2) representing the image of the pedestrian and the direct path DP 74 (FIG. 2) of a basal ganglionic module within the basal ganglia portion 54 (FIG. 2) that gates control of the foot movement to the brake. After such learning, the basal ganglia can assist in releasing the same braking in response to the same CC with less conscious attention. In a real CNS, such automated responses so generated by way of the basal ganglia tend to have a faster response time than responses generated in a fully conscious manner by the cerebral cortex alone. However, in a computer-implemented model of the central nervous system, in some arrangements, it may be desirable to minimize all response times.

Referring now to FIG. 4, an exemplary gate structure 200 has two inhibitory input nodes represented by inhibitory links 202, 204, two excitatory input nodes represented by excitatory links 206, 208, having input signals A, B, C, and D, respectively, and a single output node, represented by a link 210 having an output signal Yᵤₙᵢₜ. In the computer-implemented models described herein, active signals on inhibitory links can be dominant over active signals on excitatory links. Therefore, the logic of the gate structure 200 can be described by:

Yᵤₙᵢₜ=Ā [symbol] B̅ [symbol] (C [symbol] D), Eq. (1)

where A, B, C, and D are binary signals having values of zero or one, an overbar represents a signal compliment, [symbol] represents a logical “and” function, and [symbol] represents a logical “or” function. This equation indicates that individual inhibitory inputs are sufficiently powerful to dominate when both excitatory and inhibitory inputs are active. The capital letter designations represent binary values. The above representation is representative of the basal ganglia operating in a highly non-linear switching fashion.

While binary signal inputs are described above, the input signals need not be binary, but, as described above, can have more analog characteristics, which, in a computer-implemented model, can be represented as digital time samples, each time sample comprising a plurality of digital bits. Using lower case letters indicative of quasi-binary signals, representation of the function of the gate structure can be more generally written as:

yᵤₙᵢₜ=ƒ_{εω}_{_{c}}(−λa−λb+c+d)₀^{γ},. Eq. (2)

where, ƒ_{ε,ω}_{_{c}}(•)₀^{γ} is a sigmoidal function/operator (a low pass filter having a saturation level) with input threshold ε<<1 that saturates at a saturation value γ≦1 (see, e.g., graph in FIG. 6). This function/operator describes the potentially dynamic input-output relationship of a type 1 neuronal component (NE-1) discussed further below in conjunction with FIG. 6A. In some embodiments, the function ƒ_{ε,ωc}(•)¹₀ includes a low pass filter characteristic with a predetermined corner frequency ω_{c} greater than one hundred radians per second. With this range or corner frequencies, and input signals a, b, c, d, each having maximum value of unity and each switching at rates less than ten Hz the neuronal low-pass neuronal dynamics are negligible Eq. (2) can be approximated by:

yᵤₙᵢₜ=[−λa−λb+c+d]₀¹, Eq. (3)

where [x]₀¹=min(max [symbol] 1). If λ is quite large (>>1), then inputs a, b can suppress unit output even when each is small (<ε<<1). In particular, if total excitatory input has a maximum possible value of β (here, max(c+d)=2), then any individual inhibitory signal will be effective in suppressing output yᵤₙᵢₜ below ε whenever the input signal's value is greater than (β−ε)/λ (which is in general a quite small number).

The basal ganglia portion 54 of FIG. 2 has a single enabling excitatory input (Z^{m} below) on the link 72, which is constrained to be ≦1. The various inhibitory links shown in the basal ganglia portion 54 of FIG. 2 allow signals entering the basal ganglia portion 54 and within the basal ganglia portion 54 to be effective as soon as they each become larger than (β−ε)/λ. Therefore, the operation of the basal ganglia portion can be “quasi-binary” with signals having values >(β−ε)/λ behaving as unity, and those with lower values than ε behaving as zero. The two states will be referred to as “high” and “low”, respectively. Thus, without loss of generality, all signals in the basal ganglia can be considered to be (functionally) binary and Eq. (2) or Eq. (3) yields output closely described by Eq. (1) as long as signals on the various links of FIG. 2 spend little time taking values between ε and (β−ε)/λ (i.e., they ramp quickly). In other words, in usual operation, signals within the basal ganglia portion 54 spend the bulk of every 100 ms window assuming a value of either less than ε (or some other representative baseline value), or greater than (β−ε)/λ. (above baseline). This enables all of the circuit elements to assume stable high or low values before switching again. Thus, the gate structure 200 can be essentially function as a binary computing structure for input signals having values usually less than ε or greater than (β−ε)/λ and changing between low and high values less frequently than 10 Hz.

Moreover, the details of the waveform above the (β−ε)/λ threshold, e.g. whether “phasic” or “tonic,” are substantially irrelevant.

However, it should be recognized that, if the basal ganglia portion 54 (FIG. 2) of a computer-implemented model is used to model central nervous system (CNS) abnormalities, then the function/operator ƒ_{ε,ω}_{_{c}}(•)₀^{γ} can be represented in an abnormal fashion, having, for example, a longer time constant. In this case, internal signals may become weaker and/or sluggish in transitions resulting in abnormal operation, representative of a CNS abnormality. Alternatively, some implementations could utilize more quickly changing signals than normally seen in the CNS. To be effective, such arrangements could have neuronal components with ƒ_{ε,ωc}(•)^{γ}₀ having faster dynamics to accommodate the higher rate of switching.

Referring now to FIG. 5, another computer-implemented model 220 of the central nervous system includes a cerebral cortex portion 222 and a basal ganglia portion 224. The cerebral cortex portion 222 can be the same as or similar to the cerebral cortex portion 12 of FIG. 1 or the cerebral cortex portion 52 of FIG. 2, and the basal ganglia portion 224 can be the same as or similar to the basal ganglia portion 18 of FIG. 1 or the basal ganglia portion 54 of FIG. 2.

The cerebral cortex portion 222 includes cortical units 222a-222d. The units 222a-222c may be similar to or different than the cortical unit 222d that forms an element within a thalamocortical module 266. The cortical units 222a-222c can be the same as or similar to those that generate the CC 98 of FIG. 2, and the cortical unit 222d can be the same as or similar to one of the cortical units 108-112 of FIG. 2. Various nomenclatures used in FIG. 5 are described more fully below. Gate structure described below will be better understood from the discussion above in conjunction with FIG. 4.

The basal ganglia portion 224 (which is shown here to be but one ganglionic module, used as a replicated building block in subsequent figures) includes a striatum element 226 represented by gate structures 226a-226d, some of which are coupled to a GPe element 234, represented by a gate structure 236, via two inhibitory links 230, 232. The striatum element 226 can be the same as or similar to the striatum element 56 of FIG. 2, and the two inhibitory links 230, 232 can each be a representative constituent of the inhibitory link 76 depicted in FIG. 2 contained within a representative basal ganglionic module analogous to structure 224 depicted in FIG. 5. However, the GPe element 234 is shown to be represented by the gate structure 236, and is generally representative of further details of a particular embodiment of the GPe element 60 of FIG. 2. In some embodiments, there can be more than one gate structure 236, having similar connectivity, within the GPe element 234 of FIG. 5 or GPe element 60 of FIG. 2.

The basal ganglia portion 224 (or basal ganglionic module 224) can also include an STN element 249 represented by a gate structure 247, which can be coupled to the GPe element 234 via an excitatory link 240. In some embodiments, discussed more fully below in conjunction with FIG. 5A, there can be more than one gate structure 247, having similar connectivity, within the STN element 249 in FIG. 5 or STN element 66 of FIG. 2. The STN element 249 can be the same as or similar to the STN element 66 of FIG. 2, and the excitatory link 240 is a representative constituent of the excitatory link 86a of FIG. 2. The STN element 249 receives a control signal Z^{m} on an excitatory link 242. The excitatory link 242 is representative of the excitatory link 72 of FIG. 2.

The basal ganglia portion 224 can also include a GPi/SNr element 252 represented by a gate structure 254. In some embodiments, discussed more fully below in conjunction with FIG. 5A, there can be more than one gate structure 254, having similar connectivity, within the GPi/SNr element 252 in FIG. 5 or GPi/SNr element 58 of FIG. 2. The GPi/SNr element 252 is coupled with two inhibitory links 248, 250 from the striatum element 226. The GPi/SNr element 252 can be the same as or similar to the GPi/SNr element 58 of FIG. 2, and the two inhibitory links 248, 250 are representative of constituents of the inhibitory link 74 of FIG. 2. However, the GPi/SNr element 252 is shown to be represented by the gate structure 254, and is generally representative of further details of a particular embodiment of the GPi/SNr element 58 of FIG. 2.

The GPi/SNr element 252 can also be coupled to the GPe element 234 with an inhibitory link 238, which can be the same as, a representative constituent of, or similar to the inhibitory link 78 of FIG. 2. The GPi/SNr element 252 can also be coupled to the STN element 249 with an excitatory link 246, which can be the same as, a representative constituent of, or similar to the excitatory link 90 of FIG. 2.

An output signal from the basal ganglia portion 224 is transmitted by the GPi/SNr element 252 on an inhibitory link 258 to a thalamus unit 256 represented by a gate structure 260. As described above in conjunction with FIG. 2, the thalamus portion 52b of FIG. 2, or in this case, the thalamus unit 256, provides a pathway to and from the cerebral cortex portion, e.g., the cerebral cortex unit 222d. In some embodiments, discussed more fully below in conjunction with FIG. 5A, there can be more than one gate structures 254, having similar connectivity, within the GPi/SNr element 252, and there can be more than one thalamus unit 256. The thalamus unit 256 can be within the thalamus portion 52b of FIG. 2, and the inhibitory link 258 can be the same as, a representative constituent of, or similar to the inhibitory link 92 of FIG. 2. In some embodiments, there can be more than one gate structure 260, having similar connectivity, within the thalamus unit 256.

The thalamus unit 256 is coupled to the cortical unit 222d, which is represented as a gate structure, and which may be within the cerebral cortex portion 222. The cortical unit 222d together with the thalamus unit 256 form a “thalamocortical” module 266 having a reverberatory loop with links 262, 264. The links 262, 264 are the same as or similar to the links 94a, 94b of FIG. 2. Operation of the thalamocortical module 266 is further described below in conjunction with FIG. 6. However, let is suffice here to say that, when enabled, the thalamocortical module 266 allows a signal cu^{k} to pass through the unit 222d to provide the signal icy^{k}.

The SNc element of FIG. 2 is not shown for clarity, but it will be understood that it can be a part of the basal ganglia portion 224.

In operation, it will be understood from the logic of the various gates structures that when the control signal Z^{m} on the excitatory link 249 is an active signal (i.e., a “one”) then active signals result on excitatory links 240, 246. The inhibitory link 258 to the thalamus becomes inactive only it at least one of the signals on the inhibitory links 248, 250, 238 is active while the control signal Z^{m} is active. If both of the inhibitory links 230, 232 to the GPe element 234 have inactive signals while the control signal Z^{m} is active, then the GPe element 234 provides an active signal on the inhibitory link 238, and the signal on the inhibitory link 258 is inactive, turning on the thalamocortical module 266 allowing it to pass the signal cu^{k}. If either of the signals on the inhibitory links 230, 232 is active, then the GPe provides an inactive signal on the inhibitory link 238, and the GPi/SNr element 252 has a state controlled by the inhibitory links 248, 250 and by the control signal Z^{m}. In this condition, an active signal on either of the direct path links 248, 250 while the control signal Z^{m} is active causes the thalamocortical module 266 to turn on. Also, an active signal on either of the indirect path links 230, 232 can cause thalamocortical module 266 to turn off.

The basal ganglia portion 224 receives inputs (ⁱCC) from the cerebral cortex portion 222, which are representative of behavioral states, or cerebral cortex contexts, which can be represented by a collection of n cortical units ⁱCⱼ, j=1, 2, . . . , n, of which m are comparatively active, and n−m are much less active for some nontrivial time period. CC signal inputs to the basal ganglia portion 224 can be represented as an n-dimensional binary vector: ⁱCC=[ⁱCⱼ, ⁱC₂, . . . , ⁱCₙ]^{T}, ⁱCⱼε{0,1}. The winner(s)-take-all mechanism described above in conjunction with the striatum element 156 of FIGS. 3 and 3A responds to such inputs, providing winner(s)-take-all output on one or two of the links 248, 250, 230, 232.

If cortical input signals CC are too similar in amplitude, winners may be selected slowly and/or spurious winners may be chosen. Therefore, where processing speed of the basal ganglia portion 224 is important, processing can be facilitated by sharp transitions between widely separated values of CC input signals to the basal ganglia portion 224.

Experimental evidence suggests that real basal ganglia processing occurs in a time period of on the order of one hundred milliseconds, which can be represented by internal cumulative phase lags in a computer-implemented model of the basal ganglia portion 224. Having these phase lags, the basal ganglia portion 224 is suited to process strong cortical switching signals mat occur with a frequency on the order of ten Hz (i.e. alpha range) or slower. The basal ganglia portion 224 can be substantially insensitive to signals having higher frequency transient signals, and noise signals.

Operation of a k-th module (replication) of the basal ganglia portion 224 can be viewed as a binary valued mapping ⁱBG^{k}(•) from the i-th of an arbitrary number of n-dimensional context vectors ⁱCC to the k-th of p possible thalamocortical output target modules ⁱCY^{k} (or ⁱcy^{k}, for quasi-binary signals). This relationship can be written as:

ⁱCY^{k}=CU^{k} [symbol] ⁱBG^{k}(ⁱS^{k}_{D,1},ⁱS^{k}_{D,2}, . . . ⁱS^{k}_{I,1},ⁱS^{k}_{I,2} . . . Z^{m}), with ⁱCY^{k},ⁱS^{k}_{D,j},ⁱS^{k}_{I,j}ε{0,1}, k=1, 2, . . . , p Eq. (4)

Intended cortical output of the k-th channel of the basal ganglia portion 224 (i.e., k-th replication of the basal ganglia portion 224) can be represented by CU^{k}. An influence of the i-th context vector ⁱCC (numbered arbitrarily) on the j-th striatal units of the DP 74 and IP 76 of the k-th basal ganglionic module (e.g., 224, FIG. 5) can be represented by ⁱS^{k}_{D,j} and ⁱS^{k}_{I,j}. If ⁱS^{k}_{D, j}=1 and ⁱS^{k}_{I,j}=0, the context's influence on the striatal element is via units projecting to direct pathway and for ⁱS^{k}_{D,j}=0 and ⁱS^{k}_{I,j}=1, the influence is via units projecting to the indirect pathway.

An influence pattern of each ⁱCC does not have to be the same for each (replications) of the basal ganglionic module 224. However, as described above, a simple winner(s)-take-all learning mechanism can provide that for each k, for all j {ⁱS^{k}_{D,j}}=[{ⁱS^{k}_{I,j}} ], where italic square brackets [A] mean the logical complement of A. That is, for each k, the striatal unit (or units) that is (or are) active is (or are all) either in the DP 74 or IP 76. In other words, within any module of the basal ganglia portion 224 (i.e., replication of the basal ganglia portion 224), the activation of direct and indirect pathways by a given context ⁱCC is disjoint. Finally, whereas here for simplicity the number of unitsj in the DP and IP are treated as being the same, this need not be the case. There may be r units and s≠r units in the IP. The input-output mapping ⁱBG^{k}(•) of Eq. (4) can be expressed in greater detail and for more general signals as:

ⁱcy^{k}=cu^{k}×[[ⁱS^{k}_{D,1}] [symbol] [ⁱS^{k}_{D,2}] [symbol] . . . [symbol] [[ⁱS^{k}_{I,1}] [symbol] [ⁱS^{k}_{I,2}] [symbol] . . . [symbol] Z^{m}] [symbol] Z^{m} Eq. (5a)

ⁱcy^{k}=cu^{k}×(ⁱS^{k}_{D,1} [symbol] ⁱS^{k}_{D,2} [symbol] . . . [symbol] [ⁱS^{k}_{I,1} [symbol] . . . [symbol] [Z^{m}]] [symbol] [Z^{m}]) Eq. (5b)

=cu^{k}×(ⁱS^{k}_{D,1} [symbol] ⁱS^{k}_{D,2} [symbol] . . . [symbol] [ⁱS^{k}_{I,1} [symbol] ⁱS^{k}_{I,2} [symbol] . . . ]), for Z^{m}=1 Eq. (6a)

=cu^{k}, for Zn=0 Eq. (6b)

where the second expression follows from two applications of De Morgan's law. In Eqs. (5a) and (5b), ⁱcy^{k} represents the response to input cu^{k} when the ith cortical context vector is active. Lower case ⁱcy^{k} is used instead of ⁱCY^{k} to include the case, as in a motor cortex, where the intended cortical output is a continuously-valued, rather than binary-value signal. In other cases where the intended output is essentially binary, the expression can be in fully logical form, which can be represented by capital letters.

Eqs. (5a), (5b), (6a), and (6b) indicate that the k-th module of the basal ganglia portion 224 can be activated or deactivated according to the control signal Z^{m}, wherein the activation is provided to the STN element 249. The enabling function of the control signal Z^{m} can correspond to the operation of allowing a rote mechanism to take over control or not. Assuming that Z^{m}=1, the equations indicate that each module of the basal ganglia portion 224 nominally provides focused inhibition whenever any cortical context vector i activates any unit j within the indirect pathway. In this case ⁱS^{k}_{I,j}=1. However, this effect can be overridden if the context vector also activates any direct pathway unit ⁱS^{k}_{D,j}. Alternatively, each basal ganglionic module can provide focused enabling that can be withdrawn by applying a cortical context that zeroes all units in the direct pathway ⁱS^{k}_{D,j} and activates (setting to 1) any unit in the indirect pathway ⁱS^{k}_{I,j}. As a whole, control of the basal ganglia portion 224 can be considered to implement p independent, parallel mappings from n-dimensional binary context vectors to each element within a p-dimensional potentially binary output vector of thalamocortical module activities ⁱⁱCY=[ . . . , ⁱcy^{k}, . . . ]^{T} in response to the i-th cortical input pattern (context vector).

The binary (or quasi-binary) signal T^{k} represents a “training” signal that enables a given cortical context vector ⁱCC within the a cortex element to become associated with a particular pattern of DP and IP units within the units of the striatal element that are associated with the k-th module. That is, it establishes the mapping ⁱCC→ⁱSS^{k}_{D}, ⁱSS^{k}_{I} for the k-th module. Specifically, T^{k}=1 if the k-th thalamocortical module is currently active without basal ganglia assistance (i.e., Z^{m}=0 and cy^{k}>0). It is also to be understood here that “1” represents “high” and “0” represents “low” for quasi-binary operation. Training occurs due the temporal correlation between activities on a particular context element ⁱCᵣ, with T^{k} and DA^{k}, signals to and from SNpc and module k. Specifically, whenever T^{k}=1, then due to its generic excitatory action on the units in the striatum, it will be the case that ⁱS_{D,j}=1, and ⁱS_{I,j}=1. It should also be the case that whenever the action associated with cy^{k} high is behaviorally rewarding then DA^{k}=1, and if it is not behaviorally rewarding, then DA^{k}=0. This is handled by some value assessment circuitry elsewhere within the CNS. The weights or connection strengths between ⁱCᵣ and striatal units ⁱS^{k}_{D,j} should be such that if ⁱCᵣ=1, T^{k}=1, and DA^{k}=1, then an increase in connection strength results, while under these same conditions those weights between ⁱCᵣ and striatal units ⁱS^{k}_{I,j} should be have a much weaker increase or a progressive decrease in strength. Conversely, if either ⁱCᵣ=1, T^{k}=1 and DA^{k}=0, or ⁱCᵣ=1, T^{k}=0 and DA^{k}=1, or ⁱCᵣ=0, T^{k}=1 and DA^{k}=1, then the connection from ⁱCᵣ to ⁱS^{k}_{D,j} units should suffer a strong decrease in strength. And, under any of these same circumstances, the connection between ⁱCᵣ units and ⁱS^{k}_{I,j} should undergo a weak decrease or an increase in strength. As a result of these modifications, and the assumed mutual inhibition between ⁱS^{k}_{D,j} and ⁱS^{k}_{I,j} units, all active elements ⁱCᵣ within a context vector will become progressively preferentially connected to the DP striatal units whenever high cy^{k} is behaviorally advantageous, and will become preferentially connected to IP striatal units when high cy^{k} is behaviorally disadvantageous. Inactive ⁱCᵣ units fail to become connected to striatal units and therefore do not become involved in processing. As a result, whenever the basal ganglia mechanism is enabled (Z^{m}=1), behaviorally rewarded actions will become automatically releasable by contexts that were active when they when they were first performed deliberately. Conversely, whenever Z^{m}=1, behaviorally non-rewarded actions will become automatically inhibited by the contexts that were active when they were first performed deliberately.

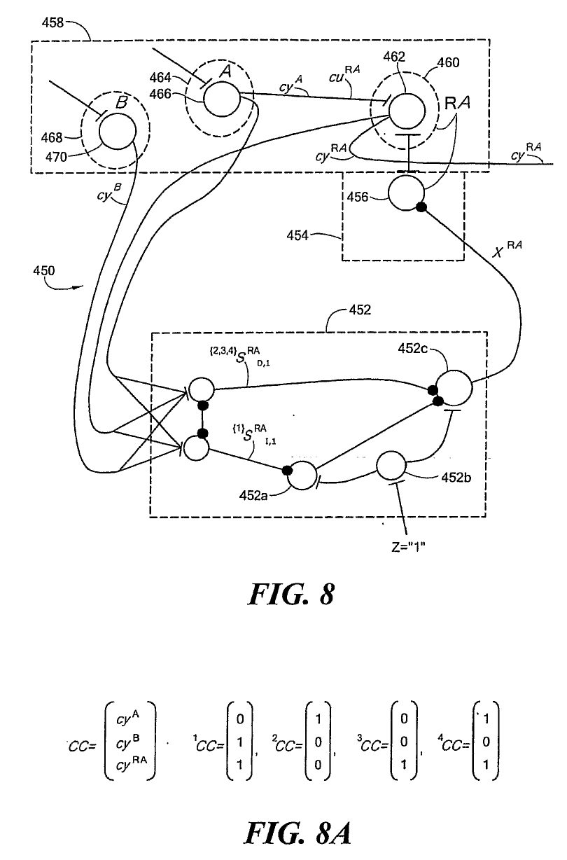

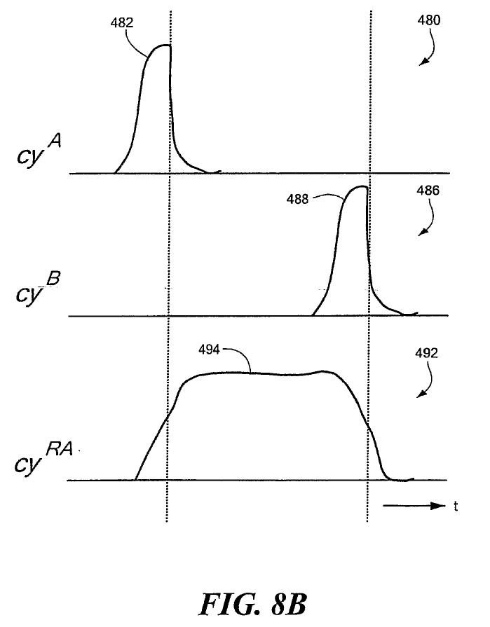

In a typical arrangement, sequences of activities can become learned “procedurally” (subconsciously or rote) so long as the reward signal DA is applied to the BG while the actions are first performed or practiced deliberately. This can occur because a context vector can represent a previous action that has been performed. Alternatively, the T^{k} signal can be supplied by the activity of some “working memory” (e.g., thalamocortical modules or registers) that is active in response to receipt of a certain external sensory inputs. In this case, internal contexts become able to substitute for external inputs to initiate the same working sensory memory patterns or percepts. Further cortical interactions between active thalamocortical modules may generate novel context registers that can become associated with other actions or percepts. Examples of storage of a sequence, or chain of procedural context vectors in frontocortical registers is discussed below in conjunction with FIGS. 8A, 8B, 9, 9A, 10, 10A.

Referring now to FIG. 5A, another computer-implemented model 278 of the central nervous system (CNS) includes a cerebral cortex portion 292 and a basal ganglia portion 280. As described above, the elements of the basal ganglia portion 224 of FIG. 5 (a basal ganglionic module used as a building block) can be replicated to form parallel basal ganglionic modules. FIG. 5A depicts a basal ganglia portion 280 that includes two of a possible larger plurality of parallel basal ganglionic modules, each one the same as or similar to the basal ganglionic module 224 of FIG. 5.

Signals associated with the first basal ganglionic module are labeled with a right hand superscript “1”, and those associated with the second basal ganglionic module are labeled with a right hand superscript “2”. The two basal ganglionic modules, (each the same as or similar to the basal ganglionic module 224 of FIG. 5) are shown to have, but need not have, identical numbers of elements. However, each basal ganglionic module should include one or more striatal, one or more GPe, and one or more GPi/SNr gate structures connected in a similar manner shown, and each GPi/SNr gate structure should transmit an output influence ⁱ[X^{k}] via inhibitory links to separate, parallel thalamic gate structures 290a, 290b.

The cerebral cortex portion 292 can be the same as or similar to the cerebral cortex portion 12 of FIG. 1 or the cerebral cortex portion 52 of FIG. 2, and the basal ganglia portion 280 can be the same as or similar to the basal ganglia portion 18 of FIG. 1 or the basal ganglia portion 54 of FIG. 2.

The cerebral cortex portion 292 includes cortical units 292a-292c, and also cortical units 292d, 292e represented as gate structures and shown to the right of the figure for clarity. The cortical units 292a-292c can provide the cortical context CC 98 of FIG. 2, and the cortical units 292d, 292e can be the same as or similar to one of the cortical units 108-112 of FIG. 2. Gate structures described below will be better understood from the discussion above in conjunction with FIG. 4.

The basal ganglia portion 280 includes a replicated pair of striatum elements. Each one of the replicated striatum elements is the same as or similar to the striatum element 226 of FIG. 5. Together, the replicated striatal elements are considered to be a “composite” striatum element 282. The striatum element 282 has units represented by gate structures 282a-282h, some of which are coupled to a (composite) GPe element 284, which is represented by a replicated pair of gate structures 284a, 284b, via two inhibitory links (not labeled). The composite striatum element 282 can be the same as or similar to the striatum element 56 of FIG. 2, and the two inhibitory links are representative of the inhibitory link 76 of FIG. 2. However, the GPe element 284 is shown to be represented by the two gate structure 284a, 284b, and is generally representative of further details of a particular embodiment of the GPe element 60 of FIG. 2.

The basal ganglia portion 280 also includes an STN element 286, represented by a single gate structure 286a, and is coupled to the composite GPe element 284 via two excitatory links (not labeled). The STN element 286 can be the same as or similar to the STN element 66 of FIG. 2, and the associated two excitatory links are representative of the excitatory link 86a of FIG. 2. The STN element 249 can receive a single control signal Z^{m} on an excitatory link 285. The excitatory link 285 is can be the same as or similar to the excitatory link 72 of FIG. 2. It should be recognized that two or more basal ganglionic modules (e.g., like 224, of FIG. 5) that form the basal ganglia portion 280 can be controlled by a common control signal Z^{m}. However, in some embodiments, each one of the separate basal ganglionic modules within the basal ganglia portion 280 can be controlled by different control signals.

The basal ganglia-portion 280 also includes a composite GPi/SNr element 288, represented by a replicated pair of gate structures 288a, 288b. The composite GPi/SNr element 288 is coupled with four inhibitory links (not labeled) to the striatum element 282. The composite GPi/SNr element 288 can be the same as or similar to the GPi/SNr element 58 of FIG. 2, and the four inhibitory links are representative of the inhibitory link 74 of FIG. 2. However, the composite GPi/SNr element 288 is shown to be represented by the two gate structures 288a, 288b, and is generally representative of further details of a particular embodiment of the GPi/SNr element 58 of FIG. 2.

The composite GPi/SNr element 288 can also be coupled to the GPe element 284 with two inhibitory links (not labeled), which are representative of the inhibitory link 78 of FIG. 2. The composite GPi/SNr element 288 can also be coupled to the STN element 286 with two excitatory links (not labeled), which are representative of the excitatory link 90 of FIG. 2.

The basal ganglia portion 280 can also be associated with a composite thalamus element 290, represented by two gate structures 290a, 290b, which can be coupled to the composite GPi/SNr element 288 via two inhibitory links (not labeled). The composite thalamus element 290 can be the same as or similar to the thalamus portion 52b of FIG. 2, and the inhibitory links are representative of the inhibitory link 92 of FIG. 2.

The composite thalamus element 290 is coupled to the two cortical units 292d, 292e, which may be within the cerebral cortex portion 292. The cortical unit 292d together with the thalamus unit 290b form a thalamocortical module the same as or similar to the thalamocortical module 266 of FIG. 5 incorporating a reverberatory (self-excitatory) loop. When enabled, the thalamocortical module having the cortical unit 292d allows a signal cu¹ to pass through the unit 292d to provide the signal cy¹.

The cortical unit 292e together with the thalamus unit 290a form another thalamocortical module the same as or similar to the thalamocortical module 266 of FIG. 5 incorporating a reverberatory (self-excitatory) loop. When enabled, the thalamocortical module having the cortical unit 292e allows a signal cu² to pass through the unit 292e to provide the signal cy².

With the above arrangement, as described above, it will be understood that there can be parallel instances (replications) within the basal ganglia portion 280, allowing the basal ganglia portion 280 to control a plurality of thalamocortical modules. It should be understood that any number of parallel instances can be provided, to control any number of thalamocortical modules.

The SNc element 64 of FIG. 2 is not shown for clarity, but it will be understood that it can be a part of the basal ganglia portion 280, and can provide learning signals T¹ and T² in the form of dopamine-like signals to the striatum element 282, causing the striatum units 282a-282d to “learn” a cortical context (CC) provided by the cerebral cortex portion 292 in ways described above.

Referring now to FIG. 6, a thalamocortical module 300 is similar to the thalamocortical module 266 of FIG. 5. The thalamocortical module 300 is represented by gate structures 304, 306. The thalamocortical module 300 can include one cerebral cortex unit 306 connected to one thalamus unit 304 by a bidirectional excitatory link designated by short orthogonal lines at both ends, representing more compactly the reverberatory connection within a thalamocortical module described previously. It will be understood that in other arrangements, discussed more fully below, one thalamus unit 304 may be bidirectionally coupled to more than one cerebral cortex unit 306. Alternatively, although not used in the embodiments depicted herein, one cerebral cortex unit 306 may be bidirectionally coupled to more than one thalamus unit 304. The brackets around the thalamocortical module 300 indicate that the input to the module from below is a binary or quasi-binary signal, and that the output is restricted to have a maximum and a minimum value. The maximum output value, max(cy^{k}), may be achieved when the binary or quasi-binary signal takes on one extreme of its possible values, and the minimum output value, min(cy^{k}), may be achieved when the quasi-binary input signal takes on the other extreme of its possible values. When the binary or quasi-binary input signal is excitatory, the maximum output value may be achieved when the input signal is high (≧1), and the minimum output value may be achieved when the input signal is low (<ε<<1). When the binary or quasi-binary input signal is inhibitory, the maximum output value may be achieved when the input signal is low (<ε<<1), and the maximum output value may be achieved when the input signal is high (≧1). When the maximum and minimum output values are to be specified explicitly, they are represented respectively by a right-hand superscript (e.g., γ) and a right-hand subscript (e.g., 0)

The thalamocortical module 300 receives an input cu^{k} and provides an output cy^{k} under control of an input signal X^{k} on an inhibitory link 302 generated by a basal ganglia portion, e.g., the basal ganglia portion 224 of FIG. 5. The inhibitory link 302 is representative of the inhibitory link 258 of FIG. 5.

As described above in conjunction with FIG. 4, a gate structure can be a binary gate structure adapted to receive input signals having substantially instantaneous transitions between values 0 and 1 (i.e., one-bit binary input signals), which can result is an output signal having a substantially instantaneous transitions in output values. However, a gate structure can be quasi-binary, receiving slower transitioning one-bit, multi-bit, or continuous input signals, resulting in a slower transitioning one-bit, multi-bit, or continuous output signal. The characteristic of a quasi-binary signal s(t) is that it usually has value either “low,” meaning close to zero (i.e., s(t)<ε<<1) where ε is some small constant or “high,” meaning greater than or equal to unity (i.e. s(t)≧1), and takes on intermediate values for only brief times relative to the time spent in the low or high state. As a result, the outputs of the networks that process quasi-binary signals spend most of the time in one or the other of two states, rather than in intermediate values.

Referring now to FIG. 6A, another block diagram of a thalamocortical module 320 shows details of an exemplary embodiment of the thalamocortical module 300 of FIG. 6. The cerebral cortex unit 306 of FIG. 6 is represented by a cerebral cortex unit 324, and the thalamus unit 304 of FIG. 6 is represented by a thalamus unit 336.

The thalamocortical module cerebral cortex unit 324 includes one or more parallel “Type I Neuronal Components” (NE-1 components). Here, two NE-1 components 350a, 350b are depicted with the understanding that a thalamocortical module cerebral cortex unit 324 may incorporate one, two, or more than two NE-1 components. The NE-1 components 350a, 350b include low-pass filter stages 328a, 328b, respectively, that transmit signals 330a 330b, respectively, to saturation stages 332a 332b, respectively. In the embodiment shown, the low-pass filter functional module 328a incorporates a gain value a1 and a principal cutoff frequency of ω_{c1} and the low pass filter stage 328b incorporates a gain value a2 and a principal cutoff frequency of ω_{c2}, where “s” is the Laplace complex frequency variable. However in general, the low pass-filter functional modules 328a, 328b may have more complex dynamics.

The NE-1 components 350a, 350b also include the saturation stages 332a, 332b, respectively. The saturation stages 332a, 332b have input threshold values ε1, ε2, respectively, and saturation level values γ1, γ2, respectively, as described further below. In the embodiment depicted, the top NE-1 component 350a receives an input signal from a “summing” node 326 and provides an output signal cy^{k} 334. The bottom NE-1 component 350b receives the input signal from the summing node 326 and provides an output signal 352 coupled to the thalamus unit 336. The input signal cu^{k} 332 is received at the summing node 326 which in turn sends its output to the two NE-1 components 350a, 350b. Here, the “summing” node 326 is shown to add its input signals. However it is to be understood that in other embodiments, any one or more of the input signals may also be subtracted from the others.

The thalamocortical module 320 also includes the thalamus unit 336, which can be the same as or similar to the thalamus unit 304 of FIG. 6 or the thalamus unit 256 of FIG. 5. The thalamus unit 336 includes a gain stage 338 having a gain value a₃, coupled to a summing node 340, which is coupled to another NE-1 component 350c. The summing node 340 receives a control signal X^{k} 348 from a basal ganglia portion, for example, a signal on the inhibitory link 92 of FIG. 2. The output from the NE-1 component 350c is coupled to the cerebral cortex unit 324 of the thalamocortical module 320 via the excitatory link 346. The NE-1 component 350c includes a low pass filter stage 328c coupled to the summing node 340 that incorporates a gain value a3 and a principal cutoff frequency of ω_{c3}. The low pass filter stage 328c provides a signal 330c to a saturation module 332c having an input threshold value ε3 and a saturation level value γ3.

Referring ahead to FIG. 6B, which describes the relationship between the input and output signals of a saturation stage, e.g., 332a-332c, a graph 360 has a horizontal and a vertical scale in arbitrary magnitude units. The horizontal scale is representative of the above-described signals 330a-330c, which are the inputs to the saturation stages 332a-332c, respectively. The vertical scale is representative of the output signal cy^{k} generated by the NE-1 component 350a of the cerebral cortex unit 324 of FIG. 6A, or of the output signal on link 352 generated by the NE-1 component 350b of the cerebral cortex unit 324, or of the output signal on link 346 generated by the thalamus unit 336 of FIG. 6A. A curve 362 is representative of the output signals generated by the saturation stages 332a-332c of FIG. 6A in response to the respective signals 330a-330c of FIG. 6A

Beginning from the left in FIG. 6B, the curve 362 assumes the lower-bound value indicated by the right-hand subscript of the expression sat_{ε}(•)^{γ}₀ (here zero, but not necessarily equal to zero), then, moving rightward, the curve 362 does not begin to change value until the input signal 330a or 330b or 330c has a value of at least ε, which is the above-described threshold value. The threshold value is indicated by the left-hand subscript of the expression sat_{ε}(•)^{γ}₀. When the input signal 330a or 330b or 330c goes higher than ε, the output signal 334 follows until it reaches a saturation level value γ, which is indicated by the right-hand superscript in the expression sat_{ε}(•)^{ε}₀. Thus, the curve 362 has the threshold value ε and the saturation level value y and here takes on the value 0 when the input is below threshold. The steepness and shape of rise of the curve 362 between threshold and saturation may be specified arbitrarily and differently for different saturation elements 328a-328c. Also, the threshold value, lower bound, and saturation level value may differ between different saturation stages 328a-328c.

Returning again to FIG. 6A, the thalamocortical module 320 also includes a connection from the output cy^{k} 334 to a filter 352 in a cerebellar portion 352 represented by the symbol CB(s). This pathway provides additional dynamics for the transmission of the thalamocortical module input signal cu^{k} to its output cy^{k}.

It will be understood that a control signal X^{k} 348 of sufficiently small magnitude, in combination with a sufficiently large output signal from gain stage 338, can result in an input signal to the saturation stage 332c that is above its threshold ε3. In this case, output from saturation stage 332c can cause the signal 330b to be at the threshold value ε2 of the saturation stage 332b

In operation, the input signal cu^{k} 322 propagates through the NE-1 component 350b to the thalamus unit 336 causing the output signal from the gain stage 338 to become sufficiently large as described above. Then, whenever the control signal 348 is low, the input to the thalamus unit 336 propagates back to the cerebral cortex unit 324 where it is summed and potentially generates a larger signal back to the thalamus unit 336. This process repeats in a “reverberatory” or self-excitatory manner until the signal 330a exceeds the threshold ε1 of the NE-1 component 350a. Thereafter, the output of the saturation stage 332a provides the nonzero output signal cy^{k} 334.

The output signal cy^{k} 334 has potentially a different magnitude than the input signal cu^{k} 332, and can have a phase lag relative to the input signal cu^{k} 332. Thus, the thalamocortical module 320 behaves like a switch, allowing the input signal cu^{k} 322 to propagate to the output signal cy^{k} 334 possibly rescaled in magnitude and filtered. The loop through the cerebellar element CB(s) 352 may add some high-pass or other filtering effect to the overall low-pass filtering effect of the thalamocortical interaction. The effective time constant of the low-pass filtering effect of the switch on the input signal cu^{k} 332 depends upon the various gains of the filter stages 328a-328c, and characteristics of the curves (e.g., 362, FIG. 6B) associated with the saturation stages 332a-332c. In the extreme of a short effective time constant, the output cy^{k} 334 saturates quickly either at some fixed proportion of the input signal cu^{k} 332 or at the value γ1. For some parameter values of the thalamocortical module, the output signal cy^{k} 334 will be sustained at the value γ1 until the input X^{k} 348 becomes high, even if the input signal cu^{k} 332 declines to zero beforehand. In the extreme of an infinite effective time constant, the output signal cy^{k} 334 represents the integral of the input signal cu^{k} 332 until the value γ1 is attained, whereafter it remains at that value.

It will be understood that a variety of factors influence a shape (e.g., a slope and saturation) and a delay of the output signal 334 (i.e., the curve 362 of FIG. 6B), including, but not limited to, a principal cutoff frequency of the low pass filter stage 328, a threshold value of the saturation stage 332a, a saturation level value of the saturation stage 332a, a gain value of the gain stage 338, a magnitude and rate of change of the input signal 322, a magnitude and a rate of change of the control signal 348, and dynamics of the filter stage CB(s) 352 associated with the cerebellar portion.

As described above in conjunction with FIG. 4, while some the signals above and some of the functional modules are described above to have continuous analog characteristics, in any of the computer-implemented models described herein, the signal can be time sampled digital signals and the functions can be digitally performed in a computer. However, in other arrangements, each unit represented in the computer-implemented model is substantially binary, having as small a time delay as possible and having as fast a state transition as possible.

While the thalamocortical module 320 is shown that is representative of the thalamocortical module, e.g., 300 of FIG. 6, it should be appreciated that the thalamocortical module 320 can be representative of other pairs of coupled units associated with the basal ganglia portion, e.g., 18 of FIG. 1, or within any other portion of the computer-implemented model 10 of FIG. 1. Thus, any two coupled units within the computer-implemented model 10 can have a threshold value, an output slope value, and an output saturation level value.

It will also be understood that any single neuronal element in the computer-implemented model 10 of FIG. 1 can be represented either by a structure the same as or similar to the NE-1 element 350a, having a low pass filter stage and a saturation stage.

Referring now to FIG. 6C, yet another block diagram of a thalamocortical module 380 is also representative of the thalamocortical module 300 of FIG. 6, and of other modules of comparable structure possibly in other portions of the CNS that serve as a switch to pass or block transmission of an input signal analogous to cu^{k} to an output signal cy^{k} according to the status of a binary or quasi-binary signal comparable to X^{k}. This representation emphasizes the switch-like function, and general low-pass filtering effect of a typical embodiment of the thalamocortical module. The thalamocortical module 380 includes a switch 382 and a transfer function 384, which is indicative of a delayed closure of the switch 382 in response to an active input signal 386.

The transfer function 384 here is a simple low-pass filter. It should be understood that more complex transfer functions can be present as determined by the filters in the thalamocortical module 320 of FIG. 6A. When a bracket symbol is used around the transfer function, it indicates that the output of the module may saturate and/or have a lower-bound value and/or an input threshold. If the values of these parameters are indicated, the output saturation level is represented by a right-hand superscript (e.g. γ), the output lower bound is represented by a right-hand subscript (e.g. 0), and the input threshold is represented by a left-hand subscript (e.g. ε). Note that in this notation the input threshold ε of the module need not equal, and in general is not equal, to any of the input thresholds (e.g. ε1, ε2, ε3) of the NE-1 components 350a-350c of FIG. 6A.

The three representations of thalamocortical modules in FIG. 6, FIG. 6A and FIG. 56C are to be understood as functionally and structurally equivalent structures that are interchangeable in the sense that these structures could substitute for each other in subsequent diagrams. Each emphasizes, for the purposes of clarity, different aspects of thalamocortical modular or equivalent switch-like modular function.

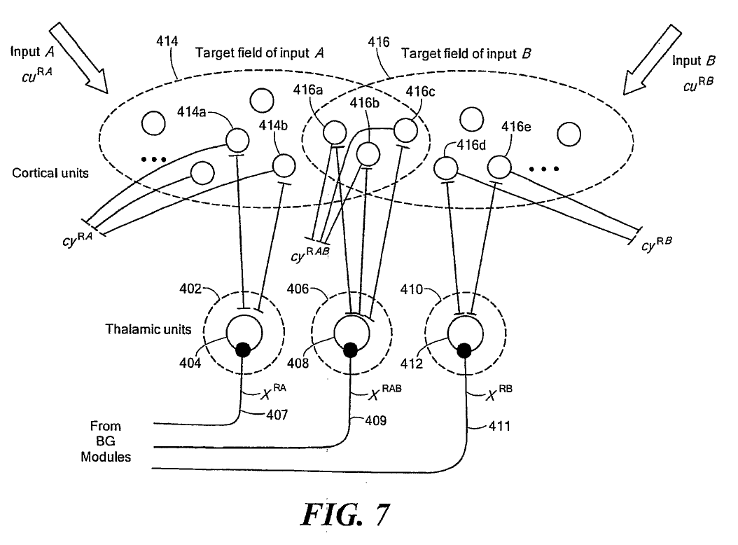

Referring now to FIG. 7, a computer-implemented model 400 includes three thalamus units 402, 406, 410, each represented by a gate structure 404, 408, 412, respectively. It should be understood from discussion above, that the thalamus units 402, 406, 410 can be associated with respective replications of a basal ganglia portion, for example, replications of the entire basal ganglia portion 54 of FIG. 2. However, in other arrangements, a single basal ganglia portion, for example, the basal ganglia portion 54, includes a plurality of thalamus units. In other words, a basal ganglia portion 54 can be replicated in total or only in part to provide the three thalamus units 402, 406, 410.

The thalamus unit 402 is coupled to two cortical units 414a, 414b within a target field 414 of a cerebral cortex portion, forming two respective thalamocortical modules, which can each be the same as or similar to the thalamocortical modules 300, 320, or 380 of FIGS. 6, 6A, and 6C, respectively. However, it will be recognized that, unlike the thalamocortical modules 300, 320, and 380, one thalamus unit 402 is coupled to two cortical units 414a, 414b, and both thalamocortical modules are controlled by one input signal on one inhibitory input link 408. This is but one way in which thalamocortical modules can be constructed within the basal ganglia portion 18 of the computer implemented model 10 of FIG. 1.

Similarly, the thalamus unit 406 is coupled to cortical four units 416a-416d within a target field 416 of the cerebral cortex portion, forming four respective thalamocortical modules, which can each be the same as or similar to the thalamocortical modules 300, 320, or 380 of FIGS. 6, 6A, and 6C, respectively. Also, the thalamus unit 410 is coupled to two units 416d, 416e within the target field 416, forming two respective thalamocortical modules.

In operation, input signals cu^{RA} (Input A) and cu^{RB} (Input B) are directed to respective output signals cy^{RA}, cy^{RAB}, and cy^{RB} under control of inputs X^{RA}, X^{RAB}, and X^{RB}, each of which results in opening (disabling) of the respective thalamocortical modules causing its output to drop to its output lower-bound value.

Referring now to FIG. 8, a computer-implemented model 450 includes a basal ganglia portion 452 having elements, which are the same as or similar to the elements of the basal ganglia portion 224 of FIG. 5. Therefore, most of the elements are not described again here. The basal ganglia portion 452 is associated with a thalamus unit 454 represented by a gate structure 456.

A cerebral cortex portion 458 includes a cortical unit 460, represented by a gate structure 462. The cortical unit 460 in combination with the thalamus unit 454 forms a thalamocortical module, which can be the same as or similar to the thalamocortical modules 300, 320, or 380 of FIGS. 6, 6A, and 6C, respectively. For the particular circuit depicted, it is assumed that the parameter settings of the thalamocortical module 454, 460 are such that once the cortical output cy^{RA} is activated by an excitation received as signal cu^{RA}, this output will be sustained at the saturation output value until the input X^{RA} goes high, disabling thalamocortical module 454, 460. Another cortical unit 464 is represented by a gate structure 466. Yet another cortical unit 468 is represented by a gates structure 470.

The cortical unit 460 receives an output cy^{A} from thecortical unit 464 as an input cu^{RA} and provides an output cy^{RA}, which, as described above in conjunction with FIG. 5, is controlled by STN element input signal Z, assumed to be steadily active (i.e. equal to unity), and striatal element signals ^{{0}}S^{RA}_{I}, and ^{{1,2,3}}S^{RA}_{D} The left-hand superscript in the symbols ^{{1}}S^{RA}_{I} and ^{{2,3,4}}S^{RA}_{D} indicates the set of cortical context vectors ⁽ⁱ⁾CC for which the signal is high (because of prior learning).

Referring ahead to FIG. 8A, in particular, the cortical context vectors ⁽¹⁾CC, ⁽²⁾CC . . . ⁽⁴⁾CC specify possible combinations of outputs of units 466, 470 and 462 that are relevant to the operation of the circuit.

Referring again to FIG. 8, the signal cy^{RA} is received by the basal ganglionic module 452, (see, e.g., 224, FIG. 5) along with a signal cy^{B} from the cortical unit 468. The output signal cy^{RA} from the thalamocortical module 454, 460 provides a feedback structure. Specifically, the above-described-winner(s)-take-all feature is assumed, on the basis of prior learning, based on a history of internal reward DA signals having been associated with the sequence of context transitions as described above in conjunction with FIGS. 3, 3A and 5 above, to cause activity of cy^{RA} or cy^{A} to activate preferentially the DP transmitting signal ^{(1,2,3})S^{RA}_{D} to the GPi/SNr element 452c. This halts transmission of signal X^{RA} via the inhibitory link and thereby enables the thalamocortical module 454, 460. Also, the winner(s)-take-all feature is assumed, on the basis of prior learning, to cause activity of cy^{B} to activate preferentially the IP transmitting signal ⁽⁰⁾S^{RA}_{I} to inhibit the GPe element 452a. This results in transmission of the output of signal X^{RA} from the GPi/SNr element 452c and subsequent disabling of thalamocortical module 454, 460. Operation of the feedback structure will be better understood from the discussion below in conjunction with FIG. 8B

Signals associated with the computer-implemented model 450 are described below in conjunction with FIG. 8B.

Referring now to FIG. 8B, three graphs 480, 486, and 492 each have horizontal scales in units of time in arbitrary units, and vertical scales in units of signal amplitude in arbitrary units. The graph 480 has a curve 482, which is indicative of the output signal cy^{A} of FIG. 8 becoming active just before a time t1 and becoming inactive at the time t1. The graph 486 has a curve 488, which is indicative of the output signal cy^{B} of FIG. 8 becoming active just before a time t2 and becoming inactive at the time t2. The graph 492 has a curve 494, which is indicative of the output signal cy^{RA} of FIG. 8 becoming active between time t1 and time t2, and inactive at other times.

Thus, the computer-implemented model 450 of FIG. 8 has an arrangement that provides set-reset register type function, wherein an active transient signal cy^{A} causes an output signal cy^{RA} to go high and remain high, and thereafter an active transient signal cy^{B} causes the output signal cy to go low. The register 454, 460 can serve, for example, as a temporary (“working”) memory register that indicates that Input A has been received and Input B has not yet been received.

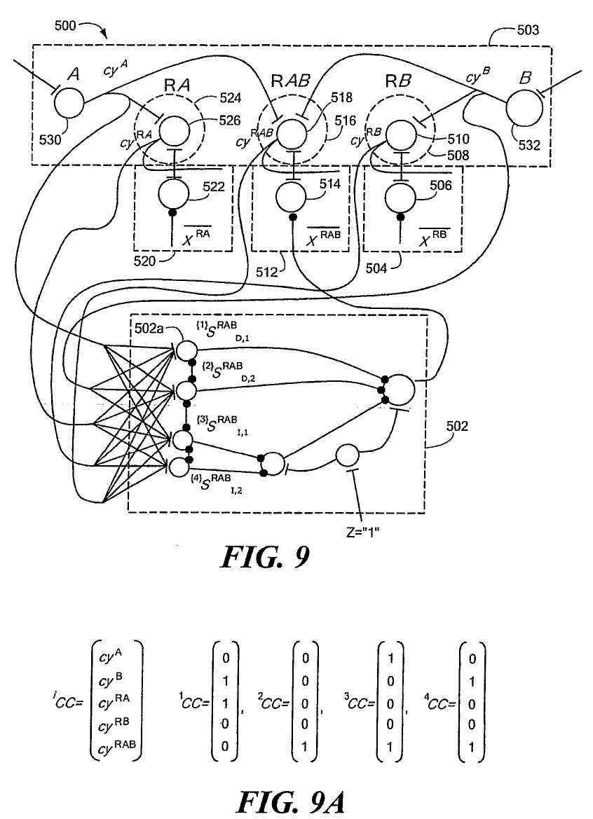

Referring now to FIG. 9, another computer-implemented model 500 includes a basal ganglia portion 502 having elements, which are the same as or similar to the elements of the basal ganglia portion 224 of FIG. 5. Therefore, most of the elements are not described again here. The basal ganglia portion 502 is coupled to a thalamus unit 512, represented by a gate structure 514 controlled by a signal X^{RAB}. The basal ganglia portion 502 can also be coupled to another thalamus unit 504, represented by a gate structure 506 controlled by a signal X^{RB}. The basal ganglia portion 502 can also be coupled to another thalamus unit 520, represented by a gate structure 522 controlled by a signal. The thalamus units 504, 512, 520 will be understood to be parallel instances (replications) to which parallel replications of the basal ganglia portion 502 are coupled, as will be understood from discussion above in conjunction with FIG. 5A. Each of the parallel instances 504, 512, 520 can be controlled by a respective replication of the basal ganglia portion 502.

Referring now to FIG. 9A, cortical context vectors ¹CC, ²CC . . . ⁴CC specify possible combinations of outputs of units 532, 524, 516, 508, and 532 that are relevant to the operation of the circuit 500 of FIG. 9.

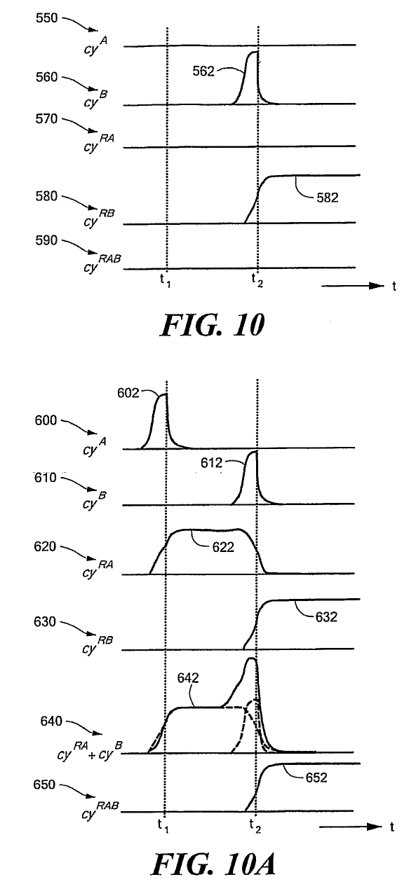

Signals associated with the computer-implemented model 500 are described below in conjunction with FIGS. 10 and 10A.

Referring now to FIG. 10, five graphs 550, 560, 570, 580, 590 each have horizontal scales in units of time in arbitrary units, and vertical scales in units of signal amplitude in arbitrary units. The graph 550 has no curve, and is representative of the signal cy^{A} in FIG. 9 being inactive. The graph 560 has a curve 562, which is indicative of the signal cy^{B} in FIG. 9 becoming active shortly before a time t2 and becoming inactive at the time t2. The graph 570 ha no curve, and is representative of the signal cy^{RA} in FIG. 9 being inactive. The graph 580 has a curve 582, which is indicative of the signal cy^{RB} in FIG. 9 becoming active shortly before the time t2 and remaining active thereafter.

It will be apparent that with the computer-implemented model 500 of FIG. 9, a signal cy^{RB} can be generated, which requires only an active signals cy^{B}.

Referring now to FIG. 10A, six graphs 600, 610, 620, 630, 640, 650 each have horizontal scales in units of time in arbitrary units, and vertical scales in units of signal amplitude in arbitrary units. The graph 600 has a curve 602, which is indicative of the signal cy^{A} in FIG. 9 becoming active shortly before a time t1 and becoming inactive at the time t1. The graph 610 has a curve 612, which is indicative of the signal cy^{B} in FIG. 9 becoming active shortly before the time t2 and becoming inactive at the time t2. The graph 620 has a curve 622, which is indicative of the signal cy^{RA} in FIG. 9 becoming active shortly before the time t1 and becoming inactive shortly after the time t2. The graph 630 has a curve 632, which is indicative of the signal cy^{RB} in FIG. 9 becoming active shortly before the time t2 and remaining active thereafter. The graph 640 has a curve 642, which is indicative of a sum of signal cy^{RA}+cy^{B} in FIG. 9 becoming active shortly before the time t1 and becoming inactive shortly after the time t2. The curve 642 is representative of a signal received by a striatum unit 502a in FIG. 9. The left-hand bracketed superscripts in the signals ^{{1}}S^{RAB}_{D,1}, ^{{2}}S^{RAB}_{D,2}, ^{{3}}S^{RAB}_{I,1}, ^{{4}}S^{RAB}_{I,2} indicate the set of indices of the cortical context vectors ¹CC, ²CC . . . ⁴CC shown above in FIG. 9A for which the corresponding striatal units transmit a high output value. Units are activated selectively because of the winner(s)-take-all mechanism and prior learning of specific mappings. The graph 650 has a curve 652, which is indicative of the signal cy^{RAB} in FIG. 9 becoming active shortly before the time t2 and remaining active thereafter.

It will be apparent that with the computer-implemented model 500 of FIG. 9, a signal cy^{RAB} can be generated only if signals cy^{A} and cy^{B} have been previously active, at least transiently. Thus, thalamocortical module 512, 516 may serve as a working memory register that indicates the prior occurrence of inputs cy^{A} and cy^{B} in that particular order. It may be appreciated that this process can be repeated indefinitely such that, for example, it would be possible to arrange that a certain thalamocortical module could serve as a register that becomes active only when hypothetical inputs A, C, B, E, D occur in that specific order. If a certain behavior is generated whenever such a register is active, then the behavior becomes associated with the sequence of prior inputs. Moreover, each action can then generate a new context vector that can be used to specify and release a subsequent action. Thus, an associational chain of working memory registers can be constructed in both directions, and can be read out as a sequence of context-specific behaviors that constitutes a behavioral program or procedure. Therefore, a procedural memory and programmed read-out mechanism can be constructed using the cortico-basal ganglionic circuits described.

Referring now to FIG. 11, another computer-implemented model 700 includes a plurality of thalamocortical modules 706a-706d coupled in parallel. It will be understood that the thalamocortical modules 706a-706d can be associated with one basal ganglia portion, e.g., 18, 54, 224, 280 of FIGS. 1, 2, 5, and 5A, respectively. However, some of the thalamocortical modules 706a-706d can otherwise be associated with other basal ganglia portions similar to those listed above.

The thalamocortical modules 706a-706d are represented as in FIG. 6C, and will be understood to each have alternate representations as in FIGS. 6 and 6A. Therefore, each one of the thalamocortical modules 706a-706d has a potential output signal as represented by curve 362 of FIG. 6B, in response to a sufficiently large input signal. A common input signal 703 is provided by a summing node 704. For the configuration shown, it will be assumed that the parameters of the thalamocortical modules 706a-706d are such that the respective output of each one of the thalamocortical modules 706a-706d rises quickly (with short time constant or large internal gain) but does not exceed each module's maximum output value, as described above in conjunction with FIG. 6A. For this reason, the bracket symbol is used in each one of the thalamocortical modules 706a-706d, although the, particular output saturation values are not specified. An integrator symbol is used generically to represent the dynamics of the module with the understanding that another transfer function may be used instead. In any case, the output signals from the thalamocortical modules 706a-706d each take on a value that is less than or equal to the respective output saturation level value, which may or may not be the same values for each one of the thalamocortical modules 706a-706d.

Output signals from the thalamocortical modules 706a-706d are received at a summing node 708, providing a signal 709. The signal 709 therefore has a maximum value that is dependent upon the number of modules 706a-706d that is active at any given time, and whether the modules 706a-706d are transmitting at or below their maximum output levels. It will be understood that in either case, the signal 709 will have a larger value when more of the thalamocortical modules 706a-706d have active output signals. Therefore, more active thalamocortical modules 706a-706d can result in a larger signal 709.

The signal 709 is received by a module 710, which, like the thalamocortical module 300 of FIG. 6, can have an input threshold value of zero and no (i.e., infinite level of) output saturation. Therefore, the bracket symbol is omitted. The corner frequency of the module 710 can be zero. Therefore, the module 710 can behave as a simple integrator. As a result, an output signal u(t) 711 can have a rate of increase given by the signal 709, which is determined by the number of active thalamocortical modules 706a-706d and the input to those units. It will be appreciated that, so long as the output from summing node 704 is nonzero, the signal 709 will be nonzero and the signal 711 will continue to rise. Once the output from the summing node 704 is zero, the signal 709 will become zero and the signal 711 will become constant. These features can be used to describe cortico-basal ganglionic feedback control of a plant 712 at different speeds as explained below.

Referring again briefly to FIGS. 6 and 6A, the module 710 is a thalamocortical module comparable to module 300 of FIG. 6. The cerebral cortex unit 306 of FIG. 6 can be represented as the cerebral cortex unit 324 of FIG. 6A. Therefore, it will be understood that the thalamocortical modules 706a-706d can transmit signals, resulting in the signal 709 transmitted within the cerebral cortex portion (e.g., 12, FIG. 1), resulting in control of movement of a plant 712.

The signal 709 is received by the module 710, resulting in a signal 711, which is sent to the plant 712, resulting in a activity (e.g., movement) of the plant 712. For example, the plant 712 can represent muscles and skeleton of a limb and the signal u(t) 711 can represent neural activation of the muscles. The movement is represented here by an angular displacement θ(t). However, the movement could also be a linear movement. In turn, the plant provides a feedback signal 714, which is coupled to the summing node 704. The summing node 704 also receives a signal 702 representative of a desired movement. When the signals 702, 714 are equal, the signals 703 are zero, and there may be no further movement of the plant 712. Whether or not movement stops depends on the dynamics in modules 706a-706d. If the associated time constant is very short and the internal gain is large, then the modules 706a-706d become zero quickly when their inputs become zero, therefore signal 709 becomes zero and the output of the large integrator 710 stops changing. Alternatively, if the modules 706a-706d have long, or infinite, time constants and approximate integrators as shown, then when the signals 703 become zero, the modules 706a-706d must be disabled via inputs from a basal ganglia module (not shown) to enable the signal 709 to become zero. The latter feature may be useful because it also enables movement stoppage to be regulated through a basal ganglia module by signals (not shown) other than the signals 703. In any case, configuration 700 is potentially highly flexible for feedback control of a plant.

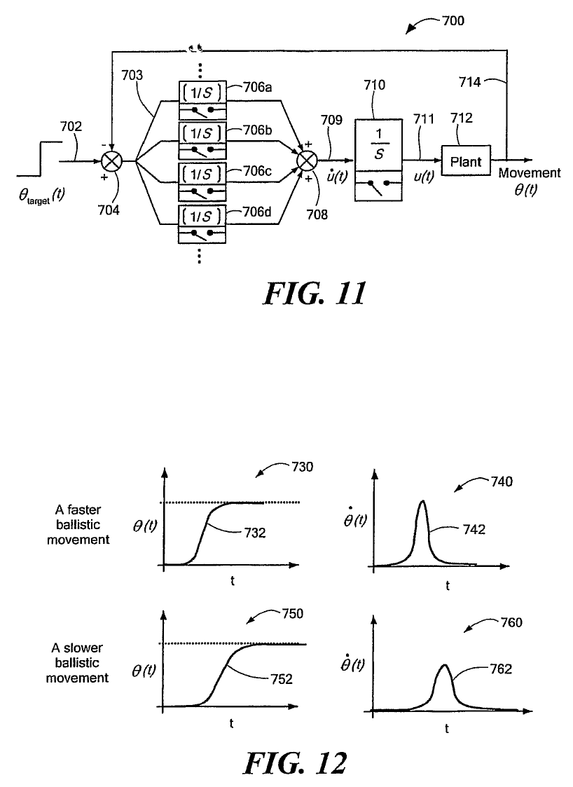

Some signals in the computer-implemented model 700 will be better understood from discussion below in conjunction with FIG. 12.

In some embodiments, the plant 712 is a limb of a robot, and the feedback signal 714 is generated by a sensor coupled to the limb, for example, an angle sensor. In other embodiments, the plant 712 is a computer-simulated plant, and the feedback signal 714 is provided by the computer-simulated plant.

Referring now to FIG. 12, a graph 730 has a horizontal scale in units of time in arbitrary units and a vertical scale in units of magnitude in arbitrary units. A curve 732 is representative of the feedback signal 714 of FIG. 11, and is indicative of a relatively fast movement of the plant 712 (FIG. 11). The relatively fast movement can be associated with a majority of the thalamocortical modules 706a-706d providing output signals.

A graph 740 has a horizontal scale in units of time in arbitrary units and a vertical scale in units of magnitude in arbitrary units. A curve 742 is representative of a derivative (slope) of the feedback signal 714 of FIG. 11, and is indicative of the relatively fast movement of the plant 712 (FIG. 11).

A graph 750 has a horizontal scale in units of time in arbitrary units and a vertical scale in units of magnitude in arbitrary units. A curve 752 is representative of the feedback signal 714 of FIG. 11, and is indicative of a relatively slow movement of the plant 712 (FIG. 11). The relatively slow movement can be associated with a minority of the thalamocortical modules 706a-706d providing output signals.

A graph 760 has a horizontal scale in units of time in arbitrary units and a vertical scale in units of magnitude in arbitrary units. A curve 762 is representative of a derivative (slope) of the feedback signal 714 of FIG. 11, and is indicative of the relatively slow movement of the plant 712 (FIG. 11).

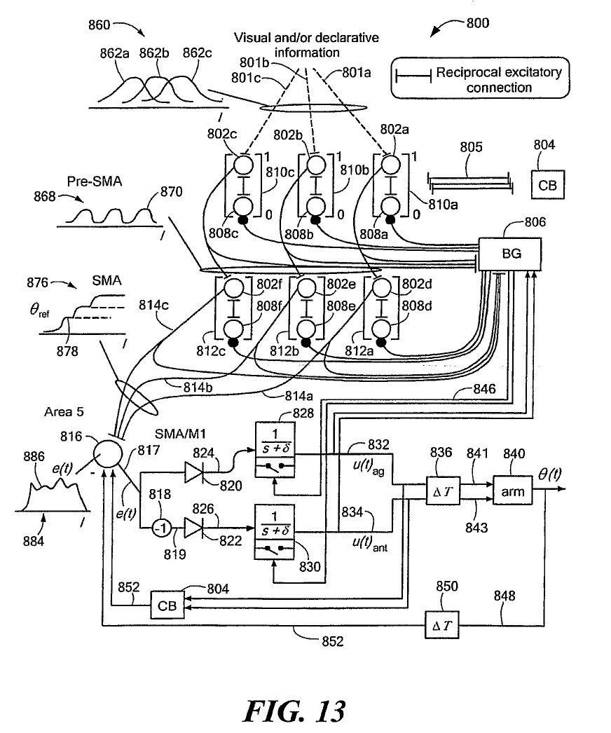

Referring now to FIG. 13, a computer-implemented model 800 includes a cerebral cortex portion having a plurality of cortical units represented by gate structures 802a-802f. The cerebral cortex portion is coupled with bidirectional links 805 to a cerebellum portion 804. The gate structures 802a-802f representing the cerebral cortex portion are also coupled to a basal ganglia portion 806 via thalamus units represented by gate structures 808a-808f. As described above, for example, in conjunction with FIG. 6, a cortical unit, e.g., 802a, coupled to a thalamus unit, e.g., 808a, can form a thalamocortical module, e.g., 810a. Six thalamocortical modules 810a-810c, 812a-812c are shown.

Three thalamocortical modules 810a-810c are coupled to receive input signals 801a-801c comprising visual and/or declarative information, for example, from simulated eyes or from optical sensors. The three thalamocortical modules 810a-810c can be representative of parts of a pre-supplemental motor area (pre-SMA) of a brain. The three thalamocortical modules 810a-810c are coupled to the other three thalamocortical modules 812a-812c, which can representative of parts of a supplemental motor area (SMA) of the brain.

The three thalamocortical modules 812a-812c can be coupled with respective links 814a-814c to a summing node 816, which can be representative of area 5 of the parietal lobe of the brain. An output 817 of the summing node 816 can be split into two output links, one of which passes through an inverting node 818, where a signal thereon is inverted, forming an inverted signal 819. The inverted signal 819 and the non-inverted signal 817 from the summing node 816 pass through respective directional coupling nodes 820, 822 that pass signals only when positively valued on two links 824, 826. The directional coupling nodes 820, 822 and the links 824, 826 can be representative of parts of the supplemental motor area (SMA) and parts of a primary motor area (M1) of the brain.

The link 824 can be coupled to a thalamocortical module 828, which can have a time constant and act as a switch. The link 824 can be coupled to another thalamocortical module 830, which can also have a time constant and act as a switch. The units 828, 830 can be the same as or similar to the unit 710 of FIG. 11, which, as described above, can have a threshold value and a saturation value. The modules 828, 830 can each be comprised of respective modules comparable to the modules 300, 320 of FIGS. 6 and 6A, respectively, but within a supplemental of primary motor area of a brain.

The module 828 can provide an agonist signal u(t)_{ag} on a link 832 through a time delay stage 836 to a plant 840, which plant can be representative, for example, of an arm.

The unit 830 can provide an antagonist signal 832 u(t)ₐₙₜ via the time delay node 836 to the plant 840. The agonist and antagonist signals u(t)_{ag}, u(t)ₐₙₜ operate in opposition to each other, each tending to cause movement of the plant 840 in opposite directions: u(t)_{ag} increases θ(t), u(t)ₐₙₜ decreases θ(t).

The plant 840 is also coupled to a time delay stage 850, which is coupled to the summing node 816 with a link 852. The summing node 816 can be representative of area 5 of the simulated brain. The agonist and antagonist signals u(t)_{ag}, u(t)ₐₙₜ on the links 832, 834 can also be coupled to the cerebellum portion 804, and the cerebellum portion 804 can provide a signal on a link 892 to the summing node 816. The agonist and antagonist signals u(t)_{ag}, u(t)ₐₙₜ on the links 832, 834 can also be coupled to the basal ganglia portion 806.

It will be understood that, in operation, the reference signal on the combined links 814a-814c can cancel signals on the links 852, 892, resulting in a zero signal on the link 817 from the summing node 816.

Graphs 860, 868, 876, 884 are representative of the computer-implemented model 800 in operation. The graphs 860, 868, 876, 884 each have time scales in units of time in arbitrary units and vertical scales in units of magnitude in arbitrary units. The graph 860 has a curves 862a-862c representative of the visual or declarative input signal 801 that are delivered sequentially and heavily overlapping in time to the three thalamocortical modules 810a-810c. The graph 868 has a curve 870 having peaks, each peak representative of an input signal to a respective one of the three thalamocortical modules 812a-812c. The graph 876 has a curve 878 representative a sum of the output signals from the three thalamocortical modules 812a-812c. The curve 878 steps, each step associated with an active output signal from one of the three thalamocortical modules 812a-812c. The graph 884 has a curve 886 representative of the error signal e(t) 817 in the parietal area 5 (summing node 816).

In operation, a visual or self-generated declarative cue to move the arm 840 through a sequence of three positions give rise to coarse, temporally overlapping cerebral cortical signals 862a-862c that are transmitted via pathways 801a-801c to the thalamocortical modules 810a-810c. Owing to their connections to cerebellum and basal ganglia as shown in FIG. 6A, the thalamocortical modules 810a-810c have dynamics that cause the thalamocortical modules 810a-810c to turn on and off more quickly, more strongly, and more independently of each other, than is the case with the signals depicted by the curve 862. The net effect is that of relative sharpening and segregating of the cerebral cortical signals 862a-862c as is shown by the curve 870. The outputs of the modules 810a-810c are integrated by the thalamocortical modules 812a-812c to produce a series of step-like inputs (e.g., curve 878) to Area 5. Possibly owing to intermediate units in area 5 (not shown) that relay the step-like inputs from modules 812a-812c to the summing node 816, the step-like inputs may be rescaled in the process to have different magnitudes. The combined signal, which is a combination of signals on the links 814a-814c, constitutes an intended movement reference command θ(t)_{ref} to three consecutive arm positions as, for example, one might perform when connecting dots with a pencil line. The difference between the reference command and the (delayed) displacement signal on the link 852 generates an error signal e(t) 817 in Area 5 which operates to generate at least one of the agonist and the antagonist signals u(t)_{ag}, u(t)ₐₙₜ on the links 832, 834, in order to move the plant 840. The feedback signal 852 operates to identify if the plant has moved to the proper position, and if so, the feedback signal 852 tends to suppress signals from the links 814a-814c from influencing the signal on the link 817. Signals on the links 814a-814c tend to promote the motion of the plant 840. As discussed in conjunction with FIG. 11, because the integrators 828 and 830 are thalamocortical modules, they can be enabled and disabled by signals from a basal ganglia (BG) module. Thus, target preparation that generates signal θ(t)_{ref} can proceed in advance of movement onset. Movement responding to the reference signal can be initiated and arrested independently by contexts (such as those representing a “go” cue) that are registered elsewhere in the cortex and act via the basal ganglia.

In some embodiments, the time delay stages 836, 850 each have a time delay of zero. However, in other embodiments, each of the time delay stages 836, 850 have a time delay in the range of about 0.01 to 0.1 seconds in order to represent real time delays associated with a real central nervous system. As described above in conjunction with FIG. 6A, each of the thalamocortical modules 810a-810c and 812a-812c can also have an associated time delay.

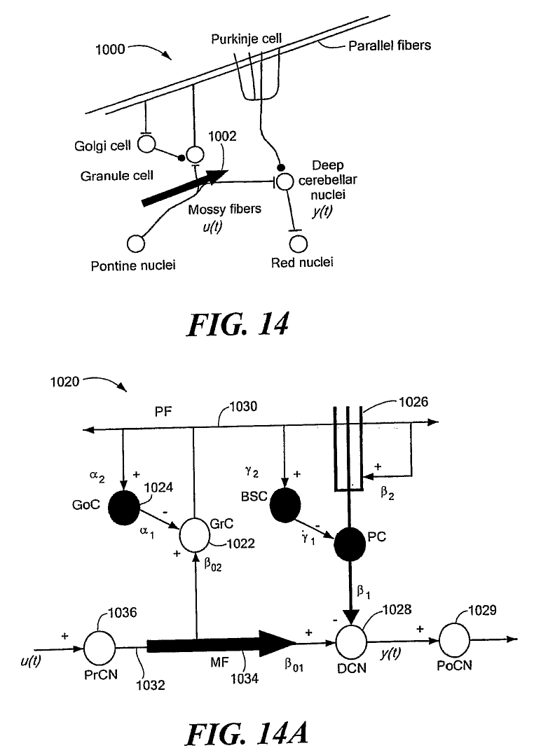

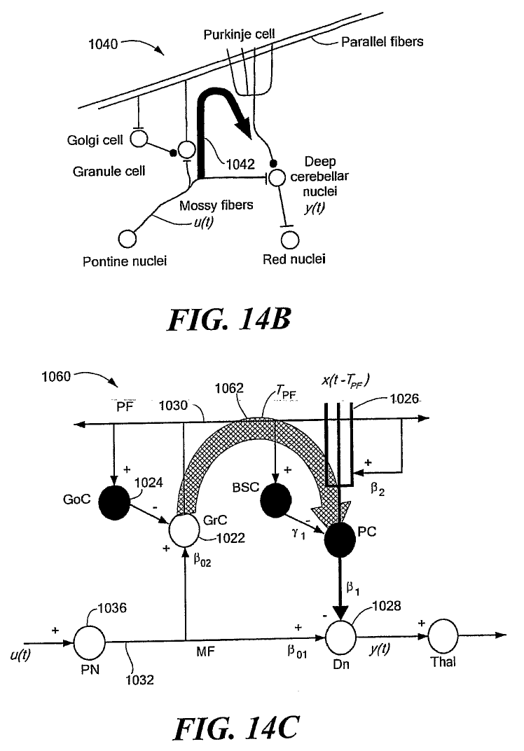

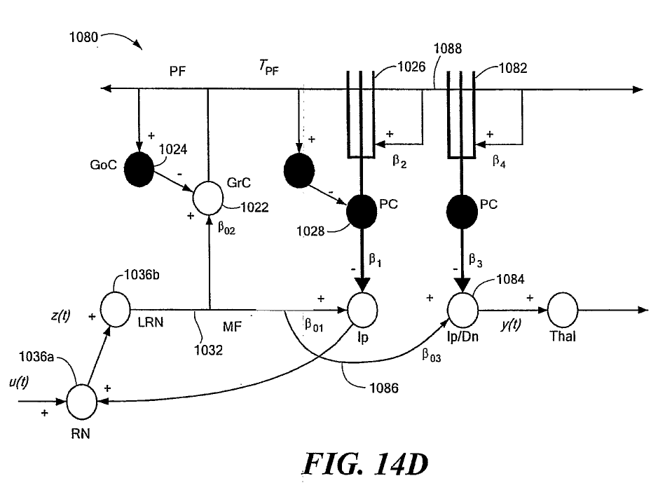

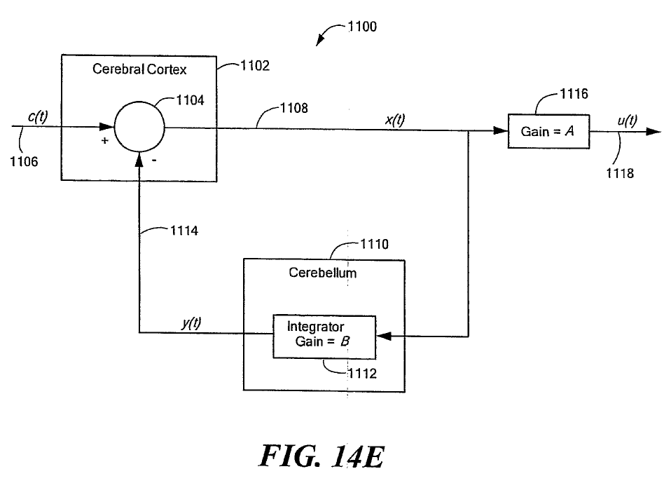

Referring now to FIGS. 14-14E, block diagrams show a variety of representations of real neuroanatomical features, which can generate a “proportion” of a signal (i.e., a gain), an integration (time integral) of a signal, and a differentiation (time derivative) of a signal.

Referring now to FIG. 14, indicated units represent groups of nerve cells and associated connecting links that correspond to the real neuroanatomical structures of a cerebellum 1000. The units shown can constitute a cerebellar module. One of ordinary skill in the art will recognize representative units that occur within specific elements of the cerebellar portion. Specifically, the units occur within, respectively, a part of one or more pre-cerebellar nuclei (PrCN elements) (for example, a parts of the pontine nuclei (PN) or of the lateral reticular nucleus (LRN) (not shown)); and within the cerebellar cortex element: units represent respectively either a collection of granule cells (GrC), a collection of Golgi cells (GoC), a collection of basket or stellate cells (BSC) (not shown), a collection of characteristically tree-shaped Purkinje cells (PC); and a portion of deep cerebellar nuclei within theDCN elements (in particular, either a portion of the dentate nucleus (Dn) or a part of the interpositus nucleus (also termed the “interposed nuclei”) (Ip)), and a part of one or more post-cerebellar nuclei (POCN elements) (for example, a red nucleus (RN) or the thalamus). One of ordinary skill in the art will also recognize lines representing collections of mossy fibers (MF) and collections of parallel fibers (PF) that travel between the PrCN, cerebellar cortex, DCN and PoCN elements. The functions of units within the PrCN elements include filtering and distributing input signals to the cerebellar portion, the function of units within the cerebellar cortex element includes selection, scaling, delaying and otherwise filtering signals from the PrCN elements as described below. The function of units within the DCN elements include collecting signals from the PrCN and cerebellar cortex elements and to allowing them to be selectively forwarded to the units within the PoCN elements which further filter and relay the signals.

In operation of a cerebellar module, a cerebellar input signal u(t) is transmitted through the pre-cerebellar nuclear unit (e.g., pontine nuclei unit) where it may undergo initial processing.

In one principal path indicated by an arrow 1002 in FIG. 14 and by an arrow 1034 in FIG. 14A, the signal traverses directly to the deep cerebellar nuclear unit, which contributes to an output signal y(t) that is accordingly directed toward one or more post-cerebellar nuclei (e.g., red nuclei).

A second principal path is indicated by an arrow 1042 in FIG. 14B and by an arrow 1062 in FIG. 14C, and is further described below.

In general, each cellular or nuclear unit can provide a gain (proportional scaling) to signals received at the cell or nucleus and can also potentially provide a threshold, a phase lag, and lower bound and upper bound (saturation) values as in the NE-1 neuronal components 350a-350c of FIG. 6A. For the purposes of simplicity, the gain feature will be emphasized in the cerebellar units described in conjunction with FIGS. 14-14D because it is the most critical neuronal feature for the operation of the cerebellar modular circuits discussed herein. The gain is related to the filter gain aᵢ in NE-1 components 350a-350c of FIG. 6A and the slope of the curve (e.g., curve 362, FIG. 6B) of the saturation stages 332a-332c within the NE-1 components 350a-350c of FIG. 6A. Again, for the purposes of simple explanation, the product of these internal neuronal gains will be taken to be unity unless otherwise indicated. In this case, the overall steady state input-output gain of a unit is dictated by the product of the input and output connection “weights,” which are described more fully below. It will be understood, however, that in any particular embodiment or application, the various gains internal to the unit and associated with its input and output connections may be specified independently.

It will be also understood that links terminating with arrows, orthogonal crossbars, or solid dots represent the action of nerve fibers (axons) that have both a transmission delay and a-connection strength (or connection “weight”). In a real central nervous system, the transmission delays are on the order of milliseconds to hundreds of milliseconds because transmission speeds are on the order of single to tens of meters per second and animal and human body dimensions are tens of meters or less.

The connection weight represents the gain (proportional scaling) in strength between the signal traveling along the axon and the resulting influence on any target neuronal element that receives the signal from the fiber. The resulting influence may be excitatory or inhibitory as explained previously in terms of the action of links. The excitatory or inhibitory character, or “sign” of the usual influence is represented by + or −, respectively and is indicated in FIGS. 14A, 14C, and 14D near a link terminal feature along with a parameter indicating the strength or weight of the connection. However, it is to be understood that under some circumstances the connection may be characterized by a sign opposite to that depicted in the figure. When no connection sign is depicted explicitly, the sign is assumed to be that of the weight parameter. When the sign of the connection is depicted explicitly, the weight parameter usually represents a positive value. However, negative strength values are not excluded. In such a case, the sign of the connection weight is opposite to that depicted explicitly. The influences of multiple connections on a target unit are assumed to be additive unless otherwise specified. In the real central nervous system (CNS), and potentially in artificial systems, there may also be a specific time delay associated with connection weight between an axon and a target neuron. In the real CNS the delay is less than 1 millisecond and is therefore usually negligible. However, it is understood here that when important for circuit operation, this “connection delay” may also be specified explicitly. It will be also understood that in a real CNS, nerve fibers, when active, transmit a series of electrical impulses whose frequency represents the intensity or magnitude of the signal being transmitted. In corresponding artificial systems, the signal may be represented by an analog or digital value that is conveyed along a wire or other communication link that corresponds to the nerve fiber. The intensity, strength (or magnitude value) of the signal on such a channel is understood to correspond to the nerve fiber impulse frequency. Artificial communication links may operate much faster or slower than the natural nerve fibers. Some of these aspects will be more apparent from discussion below.

Referring now to FIG. 14A, a computer-implemented model 1020 includes granule cell unit 1022 having an input connection gain of βₒ₂, wherein the granule cell unit 1022 is representative of the granule cell of FIG. 14. The computer-implemented model 1000 also includes a Golgi cell unit 1024 having output and input gains α₁, α₂ respectively, wherein the Golgi cell unit 1024 is representative of the Golgi cell of FIG. 14. The computer-implemented model 1000 also includes a Purkinje cell unit 1026 associated with output and input gains β₁, β₂, respectively, wherein the Purkinje cell unit 1026 is representative of the Purkinje cell of FIG. 14. The computer-implemented model 1000 also includes a deep cerebellar nuclear unit 1028 having input gains β₀₁, β₁, respectively, wherein deep cerebellar nuclear unit 1028 is representative of the deep cerebellar nuclei of FIG. 14. The computer-implemented model 1000 also includes a link 1030 representative of the parallel fibers of FIG. 14, which couples the granule cell unit 1022 and the Purkinje cell unit 1026 and the Golgi cell unit 1024 and another link 1032 representative of the mossy fibers (MF) of FIG. 14, which couples a precerebellar nuclear unit 1036- to the granule cell unit 1022 and to the deep cerebellar nuclear unit 1028. Other links correspond to links of FIG. 14 as will be apparent.

Referring now to FIG. 14B, in which like elements of FIG. 14 are shown having like designations, a group of nerve cells 1040 and associated connecting links is representative of real neuroanatomical structures of a cerebellum. As described above, in general, each cellular or nuclear unit can provide a gain, threshold, output lower and upper bound values, and phase lags to signals received at the input. Furthermore, the links, for example, the parallel fibers, can provide a time delay to the signal x(t), providing a time delayed signal x(t−T_{PF}).

In the path indicated by the arrow 1042, a signal u(t) traverses to the deep cerebellar nuclei via the granule cell, the parallel fibers, and the Purkinje cell, and contributes to the output signal y(t). The parallel fibers (PF) are known to have relatively slow signal conduction speed. Therefore, if the path indicated by the arrow 1042 includes a substantial length of the parallel fibers, the time delay from u(t) to y(t) (designated T_{PF} in figures below) will be non-trivial.

In a real cerebellum there are many different distances between granule cells and Purkinje cells, so that a wide range of signal time delays along parallel fibers is possible, from a few milliseconds to many tens of milliseconds. Moreover, the Purkinje cells 1026 may have a non-trivial associated phase lag between input and output. This lag could also contribute significant effective delay to the transmission along the path indicated by the arrow 1042. For the purposes of analysis below, such delays contributed by the Purkinje cell transmission will be subsumed within the symbol T_{PF}.

Referring now to FIG. 14C, in a computer-implemented model 1060, in which like elements of FIG. 14A are shown having like reference designations, a signal u(t) traverses according to an arrow 1062. It will be understood that if only the principal two pathways through the cerebellar module depicted in FIG. 14A and FIG. 14C are considered (i.e. when the actions of the Golgi Cell units (GoC) and basket or stellate cells untis (BSC) are neglected) then in steady state (i.e. when fluctuations due to filtering dynamics of neuronal elements within the units are neglected) the output signal y(t) is related to the input signal u(t) by:

$$\begin{matrix}y ( t ) = {β}_{01} u ( t ) - {β}_{02} {β}_{2} {β}_{1} u ( t - {T}_{PF} ) & Eq . ( 7 ) \\ = ( {β}_{01} - λ ) u ( t ) + {λ}_{1} ( u ( t ) - u ( t - {T}_{PF} ) ) , & Eq . ( 8 ) \\ where {λ}_{1} = {β}_{02} {β}_{2} {β}_{1 } & \\ \approx ( {β}_{01} - {λ}_{1} ) u ( t ) + {λ}_{1} {T}_{PF} d u / d t & Eq . ( 9 )\end{matrix}$$

From Eq. (9) it is apparent that when T_{PF} or λ₁ is very small or zero, the structure 1020 of FIG. 14A can provide “proportional” or near proportional scaling of its input according to the value of (β₀₁−λ₁). Alternatively, when T_{PF} is non-trivial, the structure 1060 can provide a mixture of proportional and derivative processing of the input signal u(t). Finally, if β₀₁=λ₁, and λ₁≠0, the output signal y(t) is proportional to the derivative of the input. It will be understood by those of ordinary skill in the art that the various gain elements associated with Purkinje cells, especially β₁, β₂, may undergo adaptive change during a learning process. Therefore, it may be reasonably considered that, in the real cerebellum, λ₁ can be adjusted to vary the relative contribution of proportional and derivative components. Therefore, the cerebellar modular circuitry 1060 can potentially provide the proportional and/or derivative components of a proportional-integrator-differentiator (PID) controller, described more fully below in conjunction with FIG. 17.

Referring now to FIG. 14D, a computer-implemented model 1080, in which like elements of FIG. 14A are shown having like reference designations, further includes a Purkinje cell unit 1082 having output and input gains of β₃, β₄ respectively wherein the Purkinje cell unit 1082 is representative of another Purkinje cell, similar to the Purkinje cell of FIG. 14. The computer-implemented model 1080 also includes a deep cerebellar nuclear unit 1084, which is similar to the deep cellular nuclei of FIG. 14, (in particular, the interpositus and/or dentate nuclei (Ip, Dn)). The units of the interpositus nucleus is known to be involved in a self-excitatory (“reverberatory”) loop involving units the (magnocellular portion of the) red nucleus (RN) 1036a and of the lateral reticular nucleus (LRN) 1036b, which are two pre-cerebellar nuclei (the red nucleus is also a postcerebellar nucleus). The computer-implemented model 1080 also includes a link 1088 representative of the parallel fibers of FIG. 14 and another link 1086 representative of the mossy fibers (MF) of FIG. 14. Other links are representative of links of FIG. 14 as will be apparent.

The computer-implemented model 1080 can provide temporal integration of its input signals. Specifically, in FIG. 14D. it will be assumed that the red nuclear unit (RN) 1036a behaves as a first order low-pass filter with output z(t) (without appreciable threshold or saturation) and input-output relation given by:

dz/dt=−(1/τ)z(t)+(u(t)+(β₀₁−λ₁)z(t)) Eq. (10)

dz/dt=(−(1/τ)+(β₀₁−λ₁))z(t)+u(t) Eq. (11)

where τ is the RN unit's time constant, and the input according to FIG. 14D is given by u(t)+(β₀₁−λ₁) z(t) with λ₁ defined as in Eq. (8). If it is also the case that (β₀₁−λ₁) ≈1/τ, then z(t)≈∂u(t) dt and the modular output is then given by:

$$\begin{matrix}y ( t ) = ( {β}_{03} - {λ}_{2} ) z ( t ) + {λ}_{2} {T}_{PF} d z / d t & Eq . ( 12 ) \\ \approx ( {β}_{03} - {λ}_{2} ) \int u ( t ) d t + {λ}_{2} {T}_{PF} u ( t ) & Eq . ( 13 )\end{matrix}$$

where λ₂=β₀₂ β₄β₃. Thus, the output y(t) will consist of a scaled integral of the input u(t) with an additional term that is approximately proportional to the input when T_{PF} is non-trivial. As is known, the various gain elements associated with Purkinje cells, especially β₃, β₄ may undergo adaptive change during a learning process that is not specified in the computer-implemented model of the central nervous system, but is recognized in the real cerebellum. Therefore, it may be considered that in the real cerebellum λ₁, and λ₂ can be adjusted to achieve effective integration of the input u(t) and to adjust the relative contributions of the integral and proportional components of this module's output y(t).

Referring now to FIG. 14E, a second temporal differentiation mechanism is described that involves the interaction between the cerebral cortex portion and the cerebellar portion of the central nervous system. Specifically, a computer-implemented model 1100 includes a cerebral cortex portion 1102 having a summing node 1104. The summing node 1104 is coupled via a link 1108 to a cerebellum portion 1110 and to a gain element 1116 having a gain of A.

The cerebellum portion 1110 includes an integrator element 1112 having a gain of B. The integrator element 1112 can be the same as or similar to the computer-implemented model 1080 of FIG. 14D. The integrator element 1112 is coupled via a link 1114 to the summing node 1104.

An input signal c(t) on a link 1106 to the summing node 1104 results in a signal x(t) on the link 1108, a signal y(t) on the link 1114, and a signal u(t) on a link 1118 from the gain element 1116.

It will be understood that the integrator element 1112 (cerebellum portion 1110) arranged in a feedback as shown, results in a temporal differentiation. Therefore, the structure 1100, which includes couplings between a cerebral cortex portion 1102 and a cerebellum portion 1110 can provide a temporal differentiation. This differentiation process is separate from, but may also operate in conjunction with the temporal differentiation process defined in association with cerebellar module 1060 in FIG. 14C. In particular, the noise handling characteristics of the two temporal differentiation mechanisms can be shown to be different.

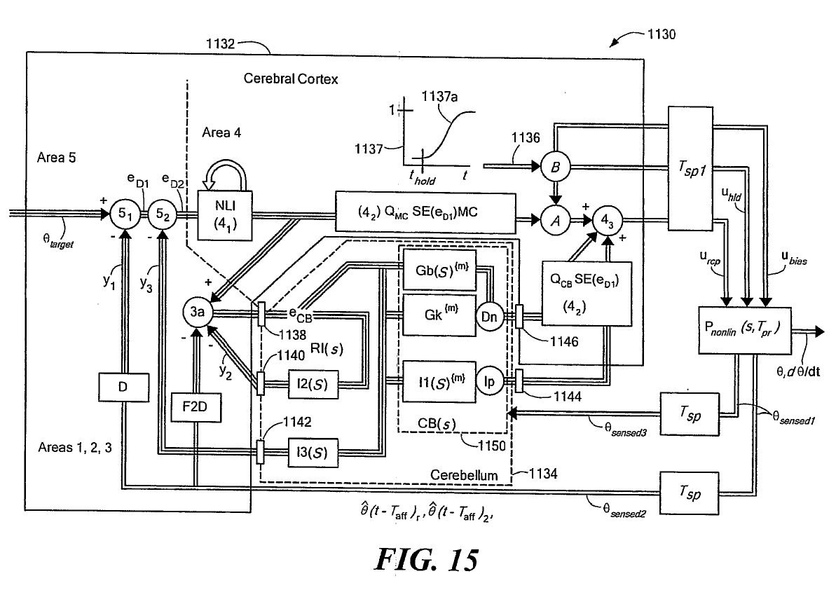

The structure 1100, having feedback of an integration to provide a temporal differentiation, is referred to herein as a “recurrent integrator,” described more fully below in conjunction with FIG. 15. When used in combination with a proportional structure, for example the structure 1020 of FIG. 14A, with a differentiating structure, for example the differentiating structure 1060 of FIG. 14C, and with an integrating structure, for example, the integrating structure 1080 of FIG. 14D, the combined structure is referred to herein as a recurrent integrator proportional-integral-derivative (RIPID) controller.

Referring now to FIG. 15, a computer-implemented model 1130 includes a cerebral cortex portion 1132 coupled to a cerebellum portion 1134. While certain numbers of channels are described below, it will be understood that, in other embodiments, the numbers of channels can be greater than or less than the indicated numbers of channels. Various summing nodes described below can be representative of computer-implemented modes of neurons.

It should be understood that the computer-implemented model 1130 can form a part of the computer-implemented model 10 of FIG. 1. However, as will be better understood from discussion below, the computer-implemented model 1130 can be a stand alone computer-implemented model, capable of controlling the plant 30 (FIG. 1), for example, via the links 30, 34 of FIG. 1.

The cerebral cortex portion 1132 can include a summing node 5₁ adapted to receive a command signal θ_{target} representative of a signal from a higher region of the cerebral cortex portion 1132, which command signal is representative of a desired (or target) position of a plant. In some embodiments, the command signal θ_{target} can be a vector signal containing more than one scalar signal, each within separate channels, and each representing the projection of a target signal vector of, for example dimension m, onto m or more (for example, n≧m) differently directed unit vectors. Each constituent signal serves as a command for units, elements, and modules concerned with operating n separate but parallel, cooperating and partially redundant processing channels. The term “partial redundancy” as used herein is understood to mean that a principle m-dimensional vector signal can be substantially reconstructed from fewer than the n signals of the parallel and cooperating channels. The representation of an m-dimensional vector signal in terms of n≧m separate but parallel, cooperating and partially redundant channels is referred to herein as a “distributed representation” (of an m-dimensional vector signal).

Commands to various actuators of a plant are synthesized from the distributed CNS vector command signals. Features of distributed representations includes that they permit: 1) better system operation in the presence of noise, damage, or other corruption of individual processing elements and modules, 2) command signals to be processed by simpler and more independent but cooperating, processing elements that as a cooperating collection can afford different net signal processing for different directions of commanded action. The former feature is important for practical implementation with real elements that individually have less than ideal computational performance. The latter feature is important for managing the potentially complex dynamic demands of intended plant action on control signal construction while using only simple individual processing elements for each channel.

In some embodiments, the command signal θ_{target} from area five of the cerebral cortex portion 1132 includes 8 separable signals each representing, for example, commanded directions of movement or position within a plane, each separated by π/4. The eight channels can be associated with any number of muscles in a real limb or with eight actuators in a mechanical limb. While eight channel-command vectors are described, there can be more than eight or fewer than eight control channels.

In some arrangements, the command signal θ_{target} can originate as a continuous signal in cortical units in a higher region of the cerebral cortex portion that, for example, extracts it from the visual system that is tracking an external object to be intercepted. In this case, the plant control action tends to be conscious. In other arrangements, the command signal θ_{target} can originate as an internally organized series of arm motions to discrete targets and would be equivalent to the signal θ_{target} in FIG. 11. In this case, θ_{target} could be represented as a sequence of cortical context vectors ⁱCC described above in conjunction with FIGS. 3, 3A and 5 and can be received from thalamocortical modules 812a-812c of FIG. 13 attributed to the SMA. In this case, the thalamocortical modules can be the same as or similar to those described above in conjunction with a basal ganglia portion, for example, the basal ganglia portion 224 of FIG. 5. With this arrangement, the resulting action described below can be more rote (i.e. subconsciously and automatically programmed) action than conscious action.

The summing node 5₁ provides an eight-channel output signal e_{P1} coupled to an input of another summing node 5₂. The summing node 5₂ provides an eight-channel output signal e_{P2} coupled to an input of a non-linear integrator NLI (4₁) that is separate from that described in the cerebellum in FIG. 14D. The nonlinear integrator NLI (4₁) provides an eight channel output signal coupled to an input of a matrix processor (4₂)Q_{MC}SE(e_{D1})MC, which can include, for example, an eight-by-eight diagonal gain matrix MC to scale all internal signal channels, an eight-by-eight diagonal selection matrix SE(eₚ₁) that selects particular outputs by suppressing a number of channels relative to others as determined by influence from area five of the cerebral cortex, and an eight-by-two recombination matrix processor Q_{MC} that converts the eight internal channels to two control actuator control channels. In general, the matrix processor (4₂)Q_{MC}SE(e_{D1})MC converts an eight channel input signal, representative of eight motion (or position) internal control signals, to two actuator control channels that could control, for example, a two degree-of-freedom plant such as an arm with a shoulder and elbow.

The matrix processor (4₂)Q_{MC}SE(e_{D1})MC provides a two-channel output signal coupled to an input of a summing node A. The summing node A provides a two-channel output signal coupled to an input of a summing node 4₃. The summing node 4₃ provides a two-channel output signal coupled to an input of a time delay stage Tₛₚ₁. In some embodiments, the time delay stage Tₛₚ₁ provides a time delay of approximately four to ten milliseconds, and is representative a time delay associated with a brain stem/spinal cord portion, for example, the brain stem/spinal cord portion 16 of FIG. 1. However, in other embodiments, the time delay can be more than or less than four milliseconds, including zero milliseconds. The time delay stage Tₛₚ₁ provides a two-channel output signal u_{rcp} having two control channels for control of action of a plant Pₙₒₙₗᵢₙ(s, Tₚᵣ).

In some embodiments, the plant Pₙₒₙₗᵢₙ(s,Tₚᵣ) includes a two-joint spino-musculoskeletal model including, for example, six muscles with activation dependent force-length and force-velocity relations, peripheral delays, low pass filter excitation activation dynamics, and phase lead primary spindle dynamics. However, other types of plant models can be used. In other embodiments, the plant Pₙₒₙₗᵢₙ(s,Tₚᵣ) is a mechanical limb having, for example, eight actuators, controlled in combinations by the two motion channels of the signal u_{rcp}.

A two channel input signal 1136 can be coupled to an input of a summing node B. The two channel input signal 1136 can be associated with a “hold” signal and a “bias”: signal to stabilize the plant Pₙₒₙₗᵢₙ(S,Tₚᵣ) at its final position by stiffening joints by agonist-antagonist muscular coactivation once controlled and to bias the position of the plant Pₙₒₙₗᵢₙ(s,Tₚᵣ) to more accurately position the plant Pₙₒₙₗᵢₙ(s,Tₚᵣ) at a target position. A graph 1137 has a curve 1137a representative of the input signal 1136.

In particular, the computer-implemented model 1130 can include an explicit gamma motor neuronal control system. Especially for more dynamically demanding movements of the plant Pₙₒₙₗᵢₙ(S,Tₚᵣ), crispness of arrival of the plant Pₙₒₙₗᵢₙ(s, Tₚᵣ) at its target position is significantly enhanced by a modest agonist-antagonist muscular coactivation when the plant arrives at the target. These affects can be controlled in a feed forward manner as shown. At a certain time t_{hold} before arrival of the plant Pₙₒₙₗᵢₙ(s,Tₚᵣ) at its target position, there can be a smooth transition in the spindle bias signal u_{bias} from the initial position to the final position. The bias shift helps to minimize antagonism of desired movement by stretch responses. At the same time the intra-motor cortical forward signal component from the nonlinear integrator NLI(4₁) can be replaced by the “hold” signal u_{hld} consisting of agonist-antagonist coactivation that is sufficiently asymmetric to also offset any passive muscular forces associated with the target position of the plant Pₙₒₙₗᵢₙ(S,Tₚᵣ). Smallest signal values for this terminal holding signal u_{hld} can be identified empirically.

Three output signals from the summing node B can be coupled to inputs of the summing node A, and to two inputs of the time delay stage Tₛₚ₁. The time delay stage Tₛₚ₁ provides a two-channel output signal u_{hld} having two control channels for holding the final position of the plant Pₙₒₙₗᵢₙ(s,Tₚᵣ). The time delay stage Tₛₚ₁ also provides a two-channel output signal u_{bias} having two control channels for biasing the final position of the plant Pₙₒₙₗᵢₙ(s,Tₚᵣ). The plant Pₙₒₙₗᵢₙ(s,Tₚᵣ) has resulting position and movement velocity θ, dθ/dt, respectively.

The plant Pₙₒₙₗᵢₙ(s, Tₚᵣ) provides a feedback signal θ_{sensed} representative of a position and a rate of change of position of the plant Pₙₒₗᵢₙ(s, Tₚᵣ). The feedback signal θ_{sensed} can be provided, for example, by suitable electronic sensors on a mechanical plant or by simulated physiological sensors on a simulated plant. For example, in a person, the feedback signal θ_{sensed} can be representative, for example, of neurological sensory feedback to the brain, indicative of a position and a rate of change of position of a part of the body.

The feedback signal θ_{sensed} is coupled to an input of a time delay stage Tₛₚ₃. The time delay stage Tₛₚ₃ can have characteristics the same as or similar to the time delay stage Tₛₚ₁. The time delay stage Tₛₚ₃ provides an output feedback signal θ_{sensed2}, which includes a time-delayed version of the feedback signals θ_{sensed}.

The feedback signal θ_{sensed} is coupled to a matrix processor F2D, which can include a two-by-eight distribution matrix D that converts the two-channel signal θ_{sensed2} to eight channels, and an eight-by-eight gain matrix F2. The matrix processor F2D provides an eight-channel output signal coupled to a summing node 3a. The summing node 3a also receives the eight-channel signal from the non-linear integrator NLI (4₁). An eight-channel output signal from the summing node 3a is coupled to the input of a time delay stage 1138. The time delay stage 1138 can provide a time delay of approximately four milliseconds. However, in other embodiments, the time delay can provide a larger or a smaller time delay, including zero milliseconds. The time delay stage 1138 is representative of real neuroanatomical delays between a real cerebral cortex portion and a real cerebellum portion.

The time delay stage 1138 provides an eight-channel output signal e_{CB} coupled to an input of an integrator I2(s). The integrator I2(s) is representative of eight of the integrators described above, for example, in conjunction with FIG. 14D. The integrator I2(s) provides an eight channel output signal coupled to an input of a time delay stage 1140, which can be the same as or similar to the time delay stage 1138. The time delay stage 1140 provides an eight-channels output signal coupled to another input of the summing node 3a. The integrator I2(s) coupled as shown will be understood to represent a recurrent integrator of the type described in conjunction with FIG. 14E.

The signal e_{CB} provided by the time delay 1138 is also coupled to inputs of a differentiator Gb(s), a gain stage Gk, and an integrator I1(s). The differentiator Gb(s) is representative of eight of the differentiators described above, for example, in conjunction with FIGS. 14B, 14C, and 14E. The gain stage Gk, is representative of the eight of the gain structures (proportions) described above, for example, in conjunction with FIGS. 14 and 14A. The integrator I1(s) is representative of eight of the integrators described above, for example, in conjunction with FIG. 14D. The differentiator Gb(s), the gain stage Gk, and the integrator I1(s) coupled as shown will be understood to represent a proportional-integrator-differentiator (PID) controller 1150. A PID controller will be understood by those of ordinary skill in the art to be a structure that can provide simple, yet powerful linear dynamic (i.e. described mathematically by a linear differential or difference equation) control of a plant. Functions performed by the differentiator Gb(s), and/or the gain stage Gk, and/or the integrator I1(s) are collectively referred to below by a function CB(s).

The differentiator Gb(s) provides an output signal and the gain stage Gk provides an output signal, which are each coupled to an input of a summing node Dn, representative of a portion of the dentate nucleus. This arrangement represents the possible summation of proportional and derivative components represented by Eq. (9) and depicted in FIG. 14C. The summing node Dn provides an output signal coupled to an input of a time delay stage 1146. The time delay stage 1146 can be the same as or similar to the time delay stage 1138.

The time delay stage 1146 provides an output signal coupled to an input of a matrix processor Q_{CB}SE(e_{D1})(4₂). The matrix processor Q_{CB}SE(e_{D1})(4₂) can include, for example, an eight-by-eight diagonal selection matrix SE(e_{D1}) that selects particular outputs by suppressing a number of channels relative to others as determined by influence from area five of the cerebral cortex, and an eight-by-two recombination matrix processor Q_{CB} that converts the eight internal channels to two control actuator control channels.

The integrator I1(s) provides an eight-channel output signal coupled to an input of a node Ip, representative of a portion of the interpositus nucleus as shown in FIG. 14D. The node Ip provides an eight-channel output signal coupled to an input of a time delay stage 1144. The time delay stage 1144 can be the same as or similar to the time delay stage 1138. The time delay stage 1144 provides an eight-channel output signal coupled to another input of the matrix processor Q_{CB}SE(e_{D1})(4₂). The matrix processor Q_{CB}SE(e_{D1})(4₂) provides two output signals, each coupled to the summing node 4₃. One of the output signals is representative of the signal provide by the time delay stage 1146 and the other output signal is representative of the signal provide by the time delay stage 1144.

The feedback signal θₛₑₙₛₑ₂ is also coupled to the input of a matrix processor D that can include two-by-eight distribution matrix. The matrix processor can covert the feedback signal θ_{sensed2}, which has two channels, to eight signals, for example signals having physical directions nπ/4 for n=0 to 7. The matrix processor D provides an output signal coupled to another input of the summing node 5₁.

The computer-implemented model 1130 can also include an integrator I3(s) coupled to receive the eight-channel signal e_{CB} from the time delay stage 1138. The integrator I3(s) provides an output signal y3 coupled to a time delay stage 1142. The time delay stage 1142 can be the same as or similar to the time delay stage 1138. The time delay stage 1142 provides an output signal coupled to another input of the summing node 5₂.

The computer-integrated model 1130 can also include another time delay stage Tₛₚ₂, which can have characteristics the same as or similar to those of the time delay stage Tₛₚ. The time delay stage Tₛₚ₂ receives the feedback signal θ_{sensed1} and provides an output signal θ_{sensed3}. The signal θ_{sensed3}. is used to select different sets of Purkinje cell units to be active within the cerebellar modules depicted within FIGS. 14A, 14C, and 14D.

In operation, action of the plant Pₙₒₙₗᵢₙ(s,Tₚᵣ) is generally controlled by the signal θ_{target} received either from a simulated high level region of the cerebral cortex portion 1132, or from thalamocortical modules associated with a basal ganglia portion (e.g., the thalamocortical modules 812a-812c in the SMA of cerebral cortex depicted in FIG. 13). The signal θ_{target} is representative of a desired action. However, the control of the plant Pₙₒₙᵢₙ(s,Tₚᵣ) can be modified by the PID controller 1134. In general, plant response behavior is dynamic in that the relationship between the plant behavior, the actuator command and the actuator action is described by a differential or difference equation. Therefore, in order for the actuators to cause the plant to have the intended behavior, the command to the actuators must be appropriate for the given dynamics. Those of ordinary skill in the art recognize a PID feedback-dependent controller as a simple, yet powerful, mechanism for generating dynamically appropriate actuator commands from error-like signals (i.e. signals that include the difference between the higher-level intended target command θ_{target} and fed-back sensory signals, such as θ_{sensed}. To be effective in causing plant response behavior to closely approximate the intended behavior, PID controller gains must be adjusted properly. The gain set selection mechanism driven by θ_{sensed3} is a mechanism for selecting the appropriate PID controller gains for a given task or set of environmental conditions.

The control of the plant Pₙₒₙₗᵢₙ(s,Tₚᵣ) is further modified by the hold and bias signal 1136. Often the trajectory of a body part en route to the target does not need to be especially precise. On the other hand, target arrival often needs to be controlled precisely. Precise control of joint position by muscles is greatly assisted by careful balancing and coactivation of agonist and antagonist muscle pairs. When coactivated, joints become stiffer and more viscous. Therefore, movement settles to rest more quickly upon reaching the target if precise hold and bias (balancing) commands are issued as the body part arrives at the target.

The control of the plant Pₙₒₙₗᵢₙ(s,Tₚᵣ) is further modified by operation of the recurrent integrator I2(s). Generally, animal feedback control systems must contend with significant transmission delays. It is understood by those ordinarily skilled in the art that delays and phase lags within feedback loops often cause the feedback loops to become unstable. However, inclusion of a differentiating circuit within the feedback loop can afford phase advancement that can often greatly assist in stabilizing the loop. The recurrent integrator I2(s), when connected in negative feedback configuration as depicted in FIG. 14E, and according to the principle presented in FIG. 15, creates an effective differentiator in the feedback loop between brainstem/spinal cord, cerebral cortex, and cerebellum. It thus acts to stabilize this “long” “transcortical” feedback loop so that it may be effective in controlling the plant despite significant delays (e.g., Tₛₚ)

The control of the plant Pₙₒₙₗᵢₙ(s,Tₚᵣ) is further modified by operation of the integrator I3(s). During operation of the system in controlling point-to-point movement, it may be noted that the output from the integrator I3(s) approximately predicts the ensuing motion of the plant. This is because of the differentiator-like operation, explained above, of the loop through summing node 3a that contains the integrator I2(s). Therefore, input to the nonlinear integrator is strongly attenuated in a predictive fashion well before the plant arrives at its target. This effect helps to offset some of the delay associated with signal θ_{sensed2} and y₁. Without this predictive feedback, the NLI may generate excessive action that results in target overshoot or other less stable plant behavior.

The control of the plant Pₙₒₙₗᵢₙ(s,Tₚᵣ) is further modified by operation of the feedback signal θ_{sensed2}. Essentially, as the plant Pₙₒₙₗᵢₙ(s,Tₚᵣ) approaches its target position, the feedback signal ∂_{sensed2}, when modified by the matrix processor D, approaches the target input signal θ_{target}, and the output signal e_{D1} from the summing node 5₁, approaches zero, stopping motion of the plant Pₙₒₙₗᵢₙ(s,Tₚᵣ).

It will be understood from discussion above that the parts of the computer-implemented model 1130 are representative of real neuroanatomical structures in a body, which are capable of simulating real neuroanatomical functions.

In some arrangement, the plant Pₙₒₙₗᵢₙ(s,Tₚᵣ) is a mechanical leg having motors or actuators to impart movement of the mechanical leg, and the plant Pₙₒₙₗᵢₙ(s,Tₚᵣ) can move with a walking motion that simulates a leg of a person walking. In other arrangements, the plant Pₙₒₙₗᵢₙ(s,Tₚᵣ) is a computer-implemented model of a leg.

Signal processing provided by the computer-implemented model 1130 can be expressed as:

y₁=Dθ_{sensed2} Eq. (14)

e_{D1}=θ_{target}−y₁ Eq. (15)

e_{D2}=e_{D1}−y₃ Eq. (16)

e_{CB}=NLI(e_{D2})−F2Dθ_{sensed2}−y₂ Eq. (17)

u_{rcp}=Q_{CB}SE(e_{D1})CB(s)e_{cB}+Q_{MC}SE(e_{D1})MC NLI(e_{D2}) Eq. (18)

The recombination matrices Q_{CB} and Q_{MC} can provide additive convergence of distributed input signals. In other words, the eight input channels can be converted to two. Direction specificity is enhanced by the output selection matrix SE(e_{D1}). In one particular embodiment, the ith element of the output selection matrix SE(e_{D1}) is unity if the signal e_{D1} is aligned with the ith channel (i.e., specifies a movement or position in a direction of the ith channel), while the adjacent elements i+1 and i−1 have sub-unity values and the remainders are zero. This effectively allows only signals on channels within thirty degrees of a direction f a channel of the signal e_{D1} to activate the columns of the recombination matrices Q_{CB} and Q_{MC}. The computer-implemented model 1130 thus includes a cerebral locus (i.e., the cerebral cortex portion 1132) for formation and integration of tracking error-type signals e_{D1}, e_{D2}, and e_{CB} a cerebellar locus (i.e., the cerebellum portion 1134) for proportional, integral and derivative coprocessing, and also for cerebrocerebellar internal feedback pathways with efference copy signals y₂ and y₃ that foster loop stability.

From the above discussion, it should be recognized that the cerebral cortex portion 1132, in combination with the cerebellum portion 1134 and a spinal cord portion represented by the time delay stages Tₛₚ₁, Tₛₚ₂ and Tₛₚ₃ can control a motion or position or other actions of a plant.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A computer-implemented model of a central nervous system, comprising:
a basal ganglia portion;
a cerebral cortex portion coupled to the basal ganglia portion; and
a cerebellum portion coupled to the cerebral cortex portion, wherein each one of the basal ganglia portion, the cerebral cortex portion, and the cerebellum portion is comprised of respective elements representative of real neuroanatomical structures of a central nervous system and the respective elements are adapted to perform functions representative of real neuroanatomical functions of the central nervous system, and wherein at least one of the basal ganglia portion, the cerebral cortex portion, or the cerebellum portion is adapted to control a plant.

2. The model of claim 1, wherein the basal ganglia portion is comprised of basal ganglia elements including a striatum element having a plurality of striatum element inputs coupled to receive a plurality of input signals from the cerebral cortex portion, wherein the striatum has a striatum element direct path output and a striatum element indirect path output.

3. The model of claim 2, wherein the striatum element is adapted to receive and to process the plurality of input signals, and adapted to generate a winner-take-all striatum element output signal on a selected one of the striatum element direct path output or the striatum element indirect path output, wherein an active signal generated at the direct path output is adapted to promote an action of the plant and an active signal generated at the indirect path output is adapted to inhibit the action of the plant.

4. The model of claim 1, wherein the basal ganglia elements comprise:
a striatum element having a plurality of striatum element inputs adapted to receive a respective plurality of input signals from the cerebral cortex portion, wherein the striatum has a striatum element direct path output and a striatum element indirect path output, wherein an active signal generated on the direct path output is adapted to promote an action and an active signal generated on the indirect path output is adapted to inhibit the action;
an external globus pallidus (GPe) element, which is represented by a GPe element gate structure having a GPe element indirect path input coupled to the striatum element indirect path output and having a GPe element indirect path output; and
an internal globus pallidus/substantia nigra pars reticulata (GPi/SNr) element, which is represented by a GPi/SNr element gate structure having a GPi/SNr element direct path input coupled to the striatum element direct path output, having a GPi/SNr element indirect path input coupled to the GPe element indirect path output, and having a GPi/SNr element output, wherein the GPi/SNr element output is adapted to couple to a thalamus unit, which is represented by a thalamus unit gate structure having a thalamus unit input coupled to the GPi/SNr element output, wherein the thalamus unit is adapted to couple a cerebral cortex unit in the cerebral cortex portion represented by a cerebral cortex gate structure, forming a thalamocortical module adapted to operate as a switch to a cortical signal.

5. The model of claim 4, wherein the striatum element is adapted to receive and to process the plurality of input signals, and adapted to generate a winner-take-all striatum element output signal on a selected one of the striatum element direct path output or the striatum element indirect path output, wherein an active signal carried on the direct path output is adapted to promote an action and an active signal carried on the indirect path output is adapted to inhibit the action.

6. The model of claim 4, wherein each one of the GPe element gate structure, the GPi/SNr element gate structure, and the thalamus unit gate structure is adapted to receive a respective one or more multi-bit digital input signals and to generate a multi-bit digital output signal according to a combination of the one or more multi-bit digital input signals.

7. The model of claim 4, wherein each one of the GPe element gate structure, the GPi/SNr element gate structure, and the thalamus unit gate structure is adapted to receive a respective one or more one-bit digital input signals and to generate a one-bit digital output signal according to a logical combination of the one or more one-bit digital input signals.

8. The model of claim 4, wherein the GPe element further includes a GPe element control input, the GPi/SNr element further includes a GPi/SNr element control input, and where the basal ganglia elements further include:
a subthalamus nucleus (STN) element represented by an STN element gate structure having an STN element control input, an STN element first control output coupled to the GPe element control input, and an STN element second control output coupled to the GPi/SNr element control input.

9. The model of claim 8, wherein each one of the STN element gate structure, the GPe element gate structure, the GPi/SNr element gate structure, and the thalamus unit gate structure is adapted to receive a respective one or more multi-bit digital input signals and to generate a multi-bit digital output signal according to a combination of the one or more multi-bit digital input signals.

10. The model of claim 8, wherein each one of the STN element gate structure, GPe element gate structure, the GPi/SNr element gate structure, and the thalamus unit gate structure is adapted to receive a respective one or more one-bit digital input signals and to generate a one-bit digital output signal according to a logical combination of the one or more one-bit digital input signals.

11. The model of claim 4, wherein the thalamus unit is represented by at least one gain stage.

12. The model of claim 4, wherein the thalamocortical module has an input node, an output node, and a control node.

13. The model of claim 12, wherein the thalamocortical unit is adapted to receive an input cortical signal at the input node and, in response to the control signal, adapted to provide an output cortical signal at the output node.

14. The model of claim 12, wherein the thalamus unit is represented by a low pass filter stage coupled to a saturation stage and the cerebral cortex unit is represented by another low pass filter stage coupled to another saturation stage.

15. The model of claim 1, wherein the cerebellum elements form a proportional-integral-derivative (PID) structure adapted to receive a signal from the cerebral cortex portion and adapted to transmit a signal to the plant in response to the signal from the cerebral cortex portion.

16. The model of claim 15, wherein the cerebellum portion further comprises a recurrent integrator element adapted to receive a signal from the cerebral cortex portion and adapted to transmit a signal to the cerebral cortex portion in response to the signal from the cerebral cortex portion.

17. The model of claim 1, wherein the cerebellum portion is adapted to receive a multi-channel position signal from the cerebral cortex portion representative of a target position of the plant, adapted to process the multi-channel input signal to generate a multi-channel output signal, and adapted to transmit the multi-channel output signal to the plant.

18. The model of claim 17, wherein the cerebellum portion is adapted to receive a feedback signal from the plant indicative of a position of the plant.

19. A computer-implemented model of a central nervous system, comprising:
a basal ganglia portion, wherein the basal ganglia portion is comprised of basal ganglia elements representative of real neuroanatomical structures of a central nervous system and the basal ganglia elements are adapted to perform functions representative of real neuroanatomical functions of the central nervous system, and wherein the basal ganglia portion is adapted to control a plant.

20. The model of claim 19, wherein the basal ganglia elements include a striatum element coupled to receive plurality of striatum element inputs adapted to receive a respective plurality of input signals representative of signals from a cerebral cortex portion of the central nervous system, wherein the striatum has a striatum element direct path output and a striatum element indirect path output.

21. The model of claim 20, wherein the striatum element is adapted to receive and to process the plurality of input signals, and adapted to generate a winner-take-all striatum element output signal on a selected one of the striatum element direct path output or the striatum element indirect path output, wherein an active signal generated at the direct path output is adapted to promote an action of the plant and an active signal generated at the indirect path output is adapted to inhibit the action of the plant.

22. The model of claim 19, wherein the basal ganglia elements comprises:
a striatum element having a plurality of striatum element inputs adapted to receive a respective plurality of input signals from the cerebral cortex portion, wherein the striatum has a striatum element direct path output and a striatum element indirect path output, wherein an active signal generated on the direct path output is adapted to promote an action and an active signal generated on the indirect path output is adapted to inhibit the action;
an external globus pallidus (GPe) element, which is represented by a GPe element gate structure having a GPe element indirect path input coupled to the striatum element indirect path output and having a GPe element indirect path output; and
an internal globus pallidus (GPi/SNr) element, which is represented by a GPi/SNr element gate structure having a GPi/SNr element direct path input coupled to the striatum element direct path output, having a GPi/SNr element indirect path input coupled to the GPe element indirect path output, and having a GPi/SNr element output, wherein the GPi/SNr element output is adapted to couple to a thalamus unit, which is represented by a thalamus unit gate structure having a thalamus unit input coupled to the GPi/SNr element output, wherein the thalamus unit is adapted to couple to a cerebral cortex unit represented by a cerebral cortex gate structure, forming a thalamocortical module adapted to operate as a switch to a cortical signal.

23. The model of claim 22, wherein the striatum element is adapted to receive and to process the plurality of input signals, and adapted to generate a winner-take-all striatum element output signal on a selected one of the striatum element direct path output or the striatum element indirect path output, wherein an active signal carried on the direct path output is adapted to promote an action and an active signal carried on the indirect path output is adapted to inhibit the action.

24. The model of claim 22, wherein each one of the GPe element gate structure, the GPi/SNr element gate structure, and the thalamus unit gate structure is adapted to receive a respective one or more multi-bit digital input signals and to generate a multi-bit digital output signal according to a combination of the one or more multi-bit digital input signals.

25. The model of claim 22, wherein each one of the GPe element gate structure, the GPi/SNr element gate structure, and the thalamus unit gate structure is adapted to receive a respective one or more one-bit digital input signals and to generate a one-bit digital output signal according to a logical combination of the one or more one-bit digital input signals.

26. The model of claim 22, wherein the GPe element further includes a GPe element control input, the GPi/SNr element further includes a GPi/SNr element control input, and wherein the basal ganglia elements further include:
a subthalamus nucleus (STN) element represented by an STN element gate structure having an STN element control input, an STN element first control output coupled to the GPe element control input, and an STN element second control output coupled to the GPi/SNr element control input.

27. The model of claim 26, wherein each one of the STN element gate structure, the GPe element gate structure, the GPi/SNr element gate structure, and the thalamus unit gate structure is adapted to receive a respective one or more multi-bit digital input signals and to generate a multi-bit digital output signal according to a combination of the one or more multi-bit digital input signals.

28. The model of claim 26, wherein each one of the STN element gate structure, GPe element gate structure, the GPi/SNr element gate structure, and the thalamus unit gate structure is adapted to receive a respective one or more one-bit digital input signals and to generate a one-bit digital output signal according to a logical combination of the one or more one-bit digital input signals.

29. The model of claim 22, wherein the thalamus unit is represented by at least one gain.

30. The model of claim 22, further including a cerebral cortex portion comprising a cerebral cortex unit representative of one or more cortical neurons and represented by a cerebral cortex unit gate structure, wherein the cerebral cortex unit is coupled to the thalamus unit forming a thalamocortical module having an input node, an output node, and a control node.

31. The model of claim 30, wherein the thalamocortical unit is adapted to receive an input cortical signal at the input node and, in response to the control signal, adapted to provide an output cortical signal at the output node.

32. The module of claim 30, wherein the thalamus unit is represented by a low pass filter stage coupled to a saturation stage and the cerebral cortex unit is represented by another low pass filter stage coupled to another saturation stage.

33. A computer-implemented model of a central nervous system, comprising:
a cerebellum portion, wherein the cerebellum portion is comprised of cerebellum elements representative of real neuroanatomical structures of a central nervous system and the cerebellum elements are adapted to perform functions representative of real neuroanatomical functions of the central nervous system, wherein the cerebellum elements form a proportional-integrator-differentiator (PID) structure, and wherein the cerebellum portion is adapted to control a plant.

34. The model of claim 33, wherein the proportional integrator differentiator (PID) structure is adapted to receive a signal from a cerebral cortex portion and adapted to transmit a signal to the plant in response to the signal from the cerebral cortex portion.

35. The model of claim 33, wherein the cerebellum portion further includes a recurrent integrator element adapted to receive a signal from a cerebral cortex portion and adapted to transmit a signal to the cerebral cortex portion in response to the signal from the cerebral cortex portion.

36. The model of claim 33, wherein the cerebellum portion is adapted to receive a multi-channel position signal from a cerebral cortex portion representative of a target position of the plant, adapted to process the multi-channel input signal to generate a multi-channel output signal, and adapted to transmit the multi-channel output signal to the plant.

37. The model of claim 36, wherein the cerebellum portion is adapted to receive a feedback signal from the plant indicative of a position of the plant.

38. The model of claim 33, further including at least one recombination matrix processor coupled to the proportional-integrator-differentiator (PID) structure.
